(19) United States
(12) Patent Application Publication
(10) Pub. No.: US 2010/0169137 A1
(43) Pub. Date: Jul. 1, 2010

(54) METHODS AND SYSTEMS TO ANALYZE DATA USING A GRAPH

(75) Inventors: Grahame Andrew Jastrebski, San Jose, CA (US); Chris Riccomini, Saratoga, CA (US); Dhanurjay A.S. Patil, Belmont, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., SAN JOSE, CA (US)

(21) Appl. No.: 12/347,914

(22) Filed: Dec. 31, 2008

(51) Int. Cl. G06Q 10/00; G06Q 40/00; G06Q 50/00; G06T 11/20

(52) U.S. Cl. 705/7; 705/30; 706/52; 345/440

(57) ABSTRACT

In an example embodiment, systems and methods to analyze data using a graph is shown. The system receives account information that identifies a first account and generates a first graph based on the first account. The graph includes a first score. Next, the system communicates a first interface to a first agent that is selected from a plurality of agents. The first interface includes the first graph. The first graph represents the first account as a first node. The first graph further represents a first plurality of accounts as a first plurality of nodes that include the first node. The first graph further represents a first plurality of account associations between the first plurality of accounts as a first plurality of edges that connect the first plurality of nodes.

### TECHNICAL FIELD

The present application relates generally to the technical field of graph analysis and, in one specific example, the use of graphs to analyze data.

### BACKGROUND

Monitoring data in various forms is sometimes useful. For example, monitoring data is sometimes useful to identify fraudulent activity, sales activity, or some other type of activity. Such data may take the form of transaction data. In some instances, the transaction data may be related to an account that may be monitored.

### BRIEF DESCRIPTION OF THE DRAWINGS

Some embodiments are illustrated by way of example and not limitation in the figures of the accompanying drawings, in which:

FIG. 1 is a diagram of an example system 10, according to an embodiment, to analyze data using graphs;

FIG. 2 is a diagram of an example system 100, according to an embodiment, to record commerce data;

FIG. 3 is a diagram of an example system 200, according to an embodiment, to record banking data;

FIG. 4 is a diagram of an example system 300, according to an embodiment, to record telecom data;

FIG. 5 is a diagram of an example system 400, according to an embodiment, to record Internet data;

FIG. 6 is a diagram of an example system 500, according to an embodiment, to aggregate transaction information;

FIG. 7A is a diagram illustrating a graph engine 620, according to an embodiment;

FIG. 7B is a block diagram illustrating a machine learning engine, according to an embodiment;

FIG. 7C is a block diagram illustrating an aggregated transaction database, according to an embodiment;

FIG. 7D is a block diagram illustrating a seed account database, according to an embodiment;

FIG. 8A is a block diagram illustrating a graph repository, according to an embodiment;

FIG. 8B is a block diagram illustrating graph information, according to an embodiment;

FIG. 9 is a block diagram illustrating graph criteria, according to an embodiment;

FIG. 10 is a block diagram illustrating graph metrics, according to an embodiment;

FIG. 11 is a block diagram illustrating a method, according to an embodiment, to analyze transaction data using graphs;

FIG. 12 is a block diagram illustrating a method, according to an embodiment, to generate a graph;

FIGS. 13A-C are diagrams illustrating interfaces, according to an embodiment, depicting the merger of two graphs;

FIG. 13D is a block diagram illustrating a method, according to an embodiment, to merge graphs;

FIG. 14A is a block diagram illustrating a method, according to an embodiment, to purge a graph;

FIG. 14B is a block diagram illustrating a method, according to an embodiment, to purge an edge from a graph;

FIG. 14C is a block diagram illustrating a method, according to an embodiment, to purge a node from a graph;

FIG. 15 is a block diagram illustrating a method, according to an embodiment, to purge a node from a graph;

FIGS. 16A-D are diagrams illustrating interfaces, according to an embodiment, that respectively include graphs;

FIG. 17 is a block diagram illustrating a method, according to an embodiment, to crawl a graph;

FIG. 18 is a diagram illustration of an interface, according to an embodiment, to rate a graph;

FIG. 19 is a diagram illustrating a concept, according to an embodiment, to generate un-ranked graph criteria;

FIG. 20 is a diagram illustrating a concept, according to an embodiment, to generate ranked graph criteria;

FIG. 21 is a diagram illustrating a concept, according to an embodiment, to insert ranked graph criteria;

FIG. 22 is a block diagram of a method, according to an embodiment, to generate graph criteria;

FIG. 23 is a block diagram of a method, according to an embodiment, to restrict accounts; and

FIG. 24 shows a diagrammatic representation of a machine in the example form of a computer system, according to an example embodiment.

### DETAILED DESCRIPTION

Embodiments of methods and systems to analyze data using a graph are illustrated. In the following description, for purposes of explanation, numerous specific details are set forth to provide a thorough understanding of some embodiments. It may be evident, however, to one skilled in the art that some embodiments may be practiced without these specific details.

In some example embodiments, systems and methods are illustrated that allows users to analyze data using a graph. In some instances that data may be descriptive of accounts and relationships between those accounts in real time. Further, the accounts may be represented as nodes in a graph and the relationships between these accounts may be represented as edges connecting these accounts. These edges may be directed edges, or non-directed edges. In some example cases, directed edges may represent transactions between the accounts. Further, in some example cases, these edges may be colored, highlighted, or otherwise distinguished to the user to inform the user as to what type of relationship between nodes they represent.

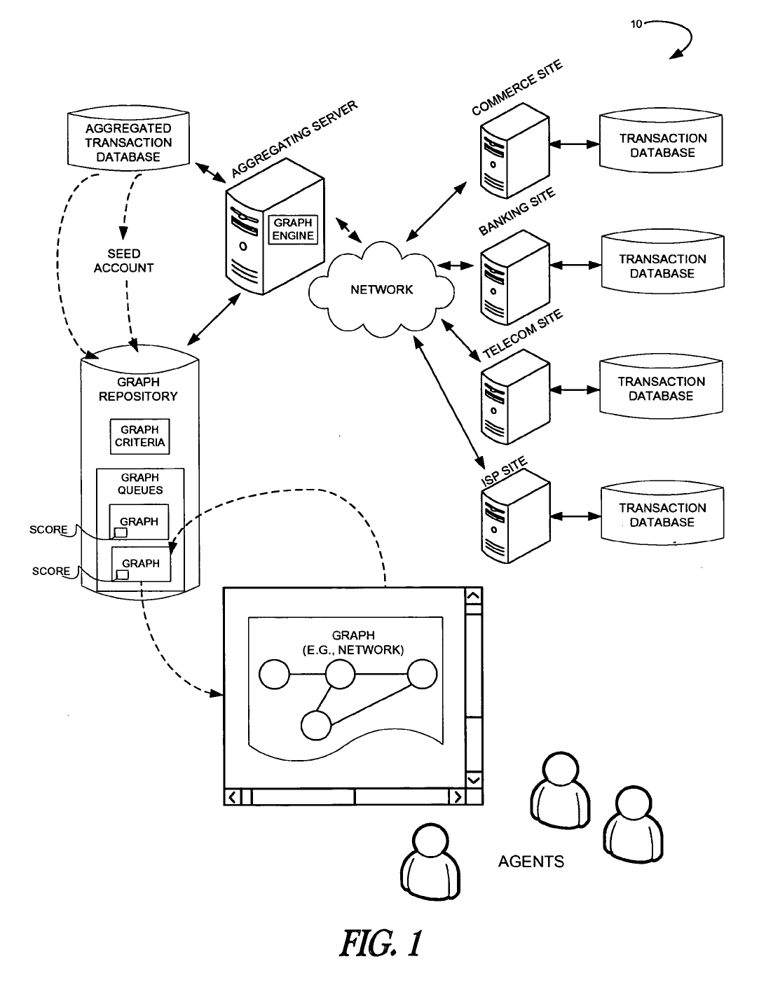

FIG. 1 is a diagram of an example system 10, according to an embodiment, to analyze data using graphs. The system 10 is shown to include a set of sites on the right including a commerce site, a banking site, a telecommunications site, and an internet service providers (ISP) site. Other embodiments may include greater or fewer sites. The sites may process transactions that result in the generation of data in the form of transaction information that is stored in respective transaction databases. The transaction information may include account information that describes accounts. Further, the transaction information may include account associations that may be used to describe the associations between accounts. For example, an association between two accounts may include a transaction that includes a flow of money from one account to another account. The aggregating server may retrieve the transaction information from the various transaction databases and store the transaction information as aggregated transaction information in an aggregated transaction database. Accordingly, the aggregated transaction information may include the account information and the account associations. The aggregating server is further shown to include a graph engine. The graph engine may be used to retrieve account information for an account from the aggregated transaction database. For example, the graph engine may use a set of rules to identify an account that as suspected of fraud. Next, the graph engine may identify other accounts that are associated with the seed account based on the account associations in the aggregated transaction information. The account association may include a transaction between a pair of accounts or links between accounts. For example, a link may include an email address, credit card number, or telephone number that is common to a pair of accounts (e.g., linked accounts). Next, the graph engine may generate a graph (e.g., network) based on the identified accounts and the associations between the accounts. Accounts may be represented as nodes in the graph. The transactions or links between these nodes may be represented as edges connecting these nodes. These edges may be directed edges, or non-directed edges. In some example cases, directed edges may represent transactions between accounts. Further, in some example cases, these edges may be colored, highlighted, or otherwise distinguished to the user to inform the user as what type of relationship between nodes they represent. In one embodiment, a graph may be generated a configured number of levels deep. For example, a seed account may be connected by edges to a first level of accounts and the first level of accounts may be connected to a second level of accounts. The graph engine may further generate a set of graph metrics for the graph and a score for the graph. For example, the score may be based on the graph metrics and/or the graph criteria, as described further below. The graph engine may store the graph in a graph queue according to the score. Finally, the graph engine may retrieve the graph from the graph queue according to the score, select an agent from a group of agents, and communicate an interface that includes the graph to the agent. The agent may review the graph to identify whether the graph is suspected of fraudulent activity or includes other interesting activity. The agent may further review the graph to identify whether the graph includes accounts that are suspected of fraudulent activity. The agent may dismiss the graph. In addition, the graph may be stored on the graph queue for further monitoring.

In a second aspect of the present disclosure, the graph engine may crawl the nodes in the graph and analyze the accounts (e.g., nodes) in the graph to generate a status for each of the respective accounts. As described above, the nodes may represent accounts and the edges connecting the nodes may represent money that flows between the accounts (e.g., transactions). For example, the graph engine may identify a node in the graph representing a seed account and crawl an edge of the graph to an adjacent node representing another account. In one embodiment, the graph engine may identify whether the adjacent account has a status of “GOOD” or “BAD.” Accordingly, the graph engine may identify the status of “BAD for all accounts represented in a graph or only portions of the accounts represented in the graph. In one embodiment, the graph engine may utilize account metrics to identify the status of the account. If the graph engine identifies the account is “GOOD,” then the graph engine may effectively prune of a part of a graph from further analysis. Otherwise, the graph engine may respond to an identification of an account as “BAD” by continuing to analyze the same part of the graph.

According to a third aspect of the present disclosure, the graph engine may be used to communicate an interface that visually presents a graph to one or more agents who may rate the graphs as “GOOD,” “BAD” or “UNSURE.” For example, an agent may rate the graph based on the entire graph or portions of the graph. In other embodiments, fewer or more ratings may be used. The graph engine may utilize the agent supplied ratings to define the above mentioned graph criteria. The graph engine may use the graph criteria to generate a score for a graph that is generated by the graph engine, as described above.

According to a fourth aspect of the present disclosure, the above processes may be used by agents to identify fraud patterns in a graph or in portions of a graph. For example, one or more accounts on a graph may be restricted.

### Other Embodiments

In the present disclosure, graphs are disclosed with nodes and edges. In the above described embodiments the nodes represent accounts and the edges represent associations that may include transactions or links between the accounts. Nevertheless, other embodiments may include graphs with nodes that represent an entity other than an account and edges that represent associations between the entities other than transactions or links, as previously described. Indeed, a person having ordinary skill in the art will recognize that the above four described aspects may be used to solve other technical problems. For example, the above aspects may be embodied as graphs that include nodes that represent persons and edges that represent interactions between those persons. Consider a graph that includes nodes that represent persons and edges that represent purchases from iTunes. Consider another graph of persons that do not make purchases from iTunes but, nevertheless, consistently trade Bennie Babies with each other. Consider also a husband and wife couple where the husband may be represented as a node on the graph for iTunes and the wife may be represented as a node on the graph for Bennie Babies. The above aspects may be used to identify the described husband and wife and to provide incentives to the husband to trade Beanie Babies and incentives to the wife to make purchases from iTunes. Stated more broadly, the above aspects may be utilized to identify cliques of buyers and sellers in a network-based marketplace and to provide incentives that might encourage the introduction of new or different products into the clique.

In some example embodiments, an image of a graph is shown in real time based using a stream of real-time account data (e.g., an account data stream), and transactions related to these accounts. In this embodiment, the image of the graph may be considered as dynamic such that it may change based upon the changing nature of the account data stream.

In some example embodiments, the aggregated transaction information used to generate a graph may be received from any one of a number of sources. These sources may include various web sites that transact business on the Internet such as commerce sites, Banking sites, or Internet Service Provider (ISP) sites. Further, sources may include Telephone Communications (Telecom) companies. Further, these sources may include certain pay sources such as EXPERIAN® services, EQUIFAX™, TRANSUNION® services, LEXIS-NEXIS® services, SHOPPING.COM® services, EBAY® services, PAYPAL® services or some other suitable service that provides transaction information to generate a graph. Some example embodiments may include retrieving transaction information from these sources based upon transactions that occur between persons using this website, or other suitable bases for supplying the transaction information. For example, the sale of goods or services over the internet as facilitated by a commerce site may be tracked, the transaction information relating to this transaction stored and a relationship between two or more accounts established, and represented as a graph. Additionally, a transfer of money for a debt owing between two accounts may be tracked by a Banking site, and a relationship established between the accounts, and represented as a graph. A further example may be the case where accounts share a common email address, or telephone numbers. In these example cases, the accounts may be shown graphically to have a relationship.

Some example embodiments may include the use of an edge in a graph to reflect the nature of the relationship been two accounts represented as nodes in the graph. For example, a directed edge in the graph may represent the flow of money during a transaction. Additionally, a particular color of an edge in a graph may represent one type of relationship between the nodes, whereas another color may represent another type of relationship.

In some example embodiments, a graph may be rendered into a visual format such that nodes are displayed as are edges between nodes. The nodes, in some embodiment, may be able to displayed visually with a high level of granularity such that additional details may be shown regarding a node. These additional details may include account information relating to a particular node. Further, in some example embodiments, information of increasing granularity may be displayed regarding the edges that connect the nodes.

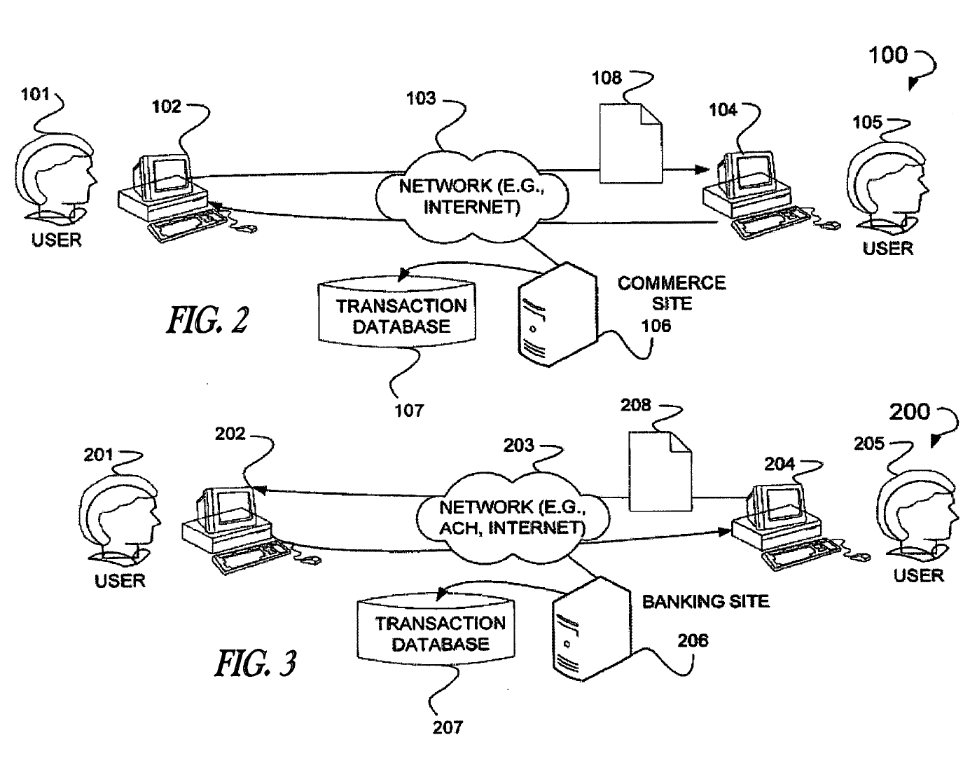

FIG. 2 is a diagram of an example system 100, according to an embodiment, to record commerce data. For example, the system 100 may record commerce data that is exchanged between two users. Shown is a user 101 utilizing a computer system 102 that sends transaction data 108 across a network 103 to a computer system 104 used by, for example, a user 105. This transaction data may be, for example, data evidencing a sale of goods or services across the network 103. This transaction data 108 may be, in some example embodiments, recorded by a commerce site 106, where the commerce site 106 utilizes one or more servers such as, for example, web servers, application servers, or database servers. In some example embodiments, the commerce site 106 may record the transaction data 108 into a transaction database 107 as transaction information for future use, or accessing. For example, the transaction information may include account information that describes accounts supported by the commerce site 106 and associations (e.g., transactions, links, etc.) between the accounts.

FIG. 3 is a diagram of an example system 200, according to an embodiment, to record banking data. For example, the system 200 may record banking data that is exchanged between two users. Illustrated is a user 201 utilizing a computer system 202 to send banking data across a network 203 that may be received by a computer system 204 used by a user 205. The user 201 may send this banking data 208 to, for example, provide money to the user 205. This money may be in the form of, for example, a wire transfer, or some other transfer of funds across a network 203. A banking site 206 may record this banking data 208. The banking site 206 may contain, for example, a web server, application server, database server, or some combination, or plurality of these various servers. Some example embodiments may include, the banking site 206 storing the banking data 208 into a transaction database 207 as transaction information for future access. For example, the transaction information may include account information that describes accounts supported by the banking site 206 and associations (e.g., transactions, links, etc.) between the accounts.

FIG. 4 is diagram of an example system 300, according to an embodiment, to record telecom data. For example, the system 300 may record an exchange of telecom data between two users across a network. Illustrated is a user 301 utilizing some type of telecommunications device 302 to send telecom data 308 across the network 303 to another telecom device 304 that is used by, for example, a user 305. This telecom data 308 may be packet switched data, or data sent along a dedicated circuit. Further, this network 303 may be, for example, a Plain Old Telephone System (POTS) base network, a Code Divisional Multiple Access (CDMA) type network, a Global System for Mobile (GSM) communications based network, or some other suitable network. In some example embodiments, telecom site 306 may record this telecom data 308. This telecom site 306 may include, for example, a web server, application server, database server or some combination, or plurality of these various server types. This telecom data may be stored into a transaction database 307 by the telecom site 306. The telecommunication device 302 may include, for example, a traditional telephone, a cell phone, a Personal Digital Assistant (PDA), or some other suitable device capable of utilizing the network 303. Some example embodiments may include, the telecom site 306 storing the telecom data 308 into a transaction database 307 as transaction information for future access. For example, the transaction information may include account information that describes accounts supported by the telecom site 306 and associations (e.g., transactions, links, etc.) between the accounts.

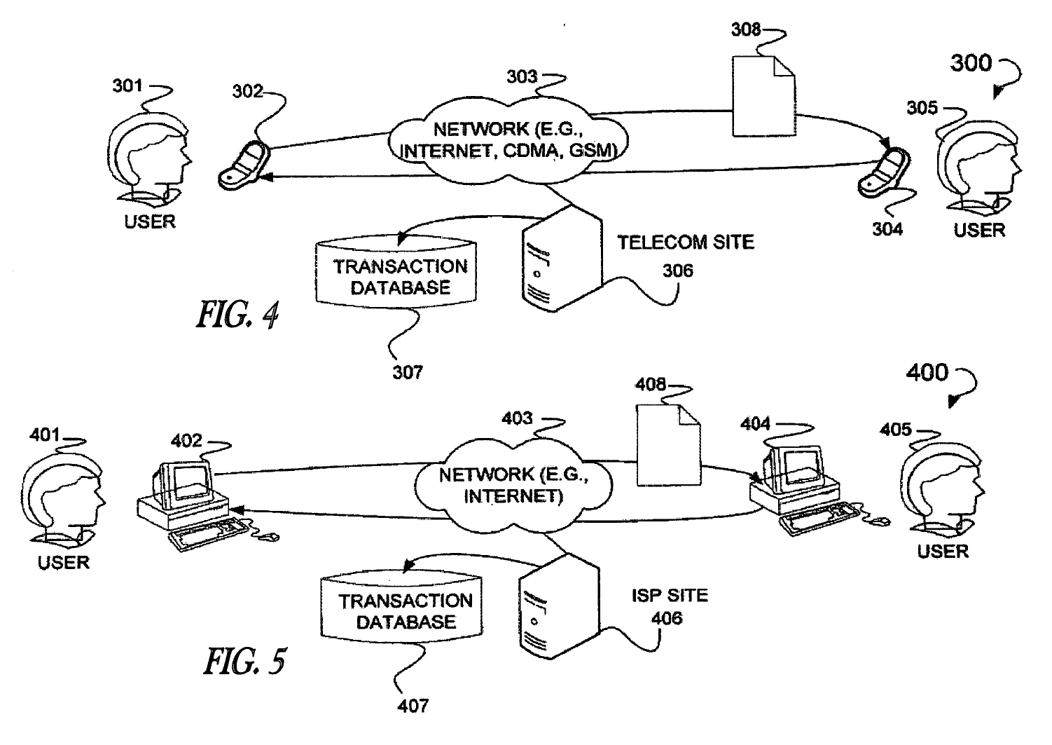

FIG. 5 is diagram of an example system 400, according to an embodiment, to record Internet data. For example, the system 400 may record the exchange of Internet data between two users. Shown is a user 401 utilizing a computer system 402 to transmit Internet data 408 across to network 403 to a user 405 utilizing a computer system 404. In some example embodiments, the Internet data 408 may be some type of packetized data. This packetized data may utilize the Internet and, in doing so, utilize any one of a number of protocols as described in the Transmission Control Protocol/Internet Protocol (TCP/IP) stack model, or the Open Systems Interconnection (OSI) OSI model. Protocols that may be used in the transmission or exchange of the Internet data 408 may include, for example, TCP, IP, User Datagram Protocol (UDP), the Hyper Text Transfer Protocol (HTTP), Frame Relay, or some other suitable protocol. In some example embodiments, an Internet Service Provider (ISP) site 406 may record the Internet data 408 sent across the network 403. This ISP site 406 may include, for example, a web server, application server, database server, or some combination or plurality of these various types of servers. This Internet data 408 may be stored by the ISP site 406 into a transaction database 407 as transaction information for future access. For example, the transaction information may include account information that describes accounts supported by the ISP site 406 and associations (e.g., transactions, links, etc.) between the accounts.

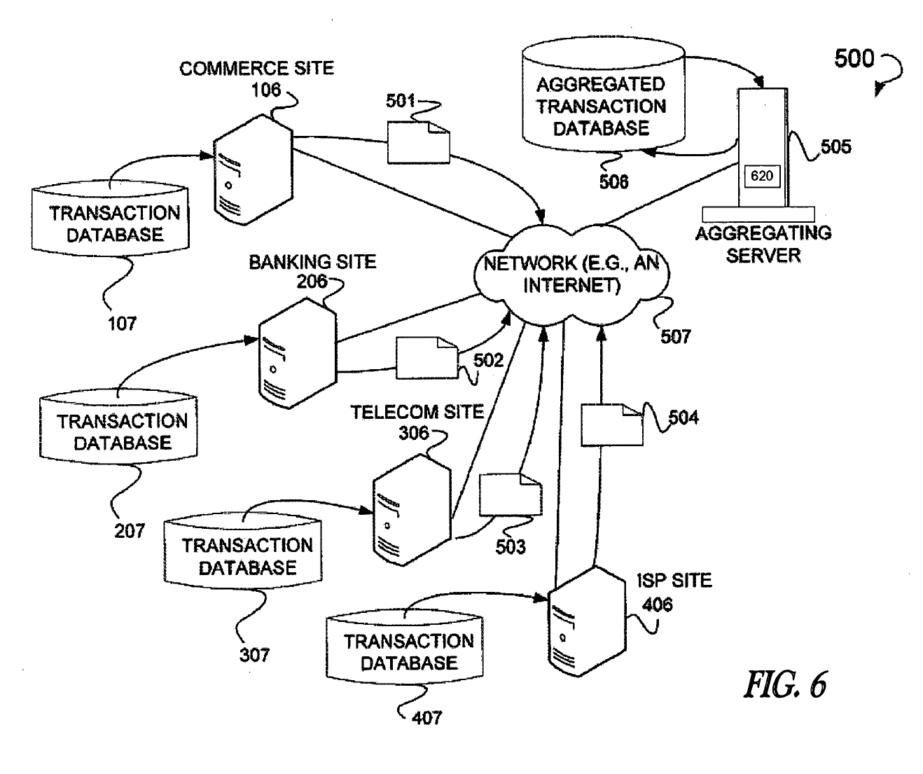

FIG. 6 is a diagram of an example system 500, according to an embodiment to aggregate transaction information. For example, the system 500 may aggregate various types of transaction information stored on the previously referenced commerce site 106, banking site 206, telecom site 306 and ISP site 406. Shown is an aggregating server 505 that is operably connected to an aggregated transaction database 506. This aggregating server 505 and an associated aggregated transaction database 506 may, in some example embodiments, receive transaction information from the previously referenced commerce site 106, banking site 206, telecom site 306, and/or ISP site 406. This transaction information may be received in the form of, for example, an aggregated commerce site data packet 501, an aggregated banking site data packet 502, an aggregated telecom site data packet 503, and/or an aggregated ISP site data packet 504. These various data packets (e.g., 501, 502, 503, or 504) may be transmitted across a network 507 to be received by the aggregating server 505. In some example embodiments, a number of these various data packets (e.g., 501, 502, 503, or 504) may be transmitted across the network 507. This aggregating server 505 may store these various data packets into the aggregated transaction database 506 in the form of aggregated transaction information. In some example embodiments, the aggregating server 505 may generate some type of database query utilizing, for example, HTTP, or some other suitable protocol where this protocol may be used to, for example, query one of the previously referenced sites (e.g., 106, 206, 306, or 406). Once this query is tendered to one or more of these previously referenced sites, one or more of these previously referenced sites may access an associated transaction database (e.g., 107, 207, 307, or 407). For example, once the commerce site 106 receives a query from the aggregating server 505, it may query its associated transaction database 107 to retrieve the previously referenced commerce site data packet 501. Similarly, the telecom site 306, upon receiving a query from the aggregating server 505, may query its associate transaction database 307 to retrieve data to generate the telecom site data packet 503 and to send this on to the aggregating server 505 across the network 507. In some example embodiments, the aggregating server 505 may utilize a Structured Query Language (SQL), or some other suitable database query language (e.g., Multi-Dimensional Expression (MDX) Language) to query one or more of the previously referenced sites (e.g., 106, 206, 306 or 406).

In some example embodiments, rather than the aggregating server 505 storing these various data packets into the aggregated transaction database 506 as aggregated transaction information, the aggregating server 505 includes a graph engine 620 that receives the aggregated transaction information, processes the transaction information, and generates a graph in real time. In one example embodiment, a TCP/IP connection is established between the aggregating server 505 and the previously referenced sites 106, 206, 306, and 406. In some example embodiments, a TCP/IP connection may be established with a pay source. In certain case, UDP/IP may be used to establish a connection with the previously referenced sites 106, 206, 306, and 406, and/or a pay source. Once a connection is established, protocols such as HTTP, or even a Real Time Streaming Protocol (RTSP) may be used to generate an account data stream.

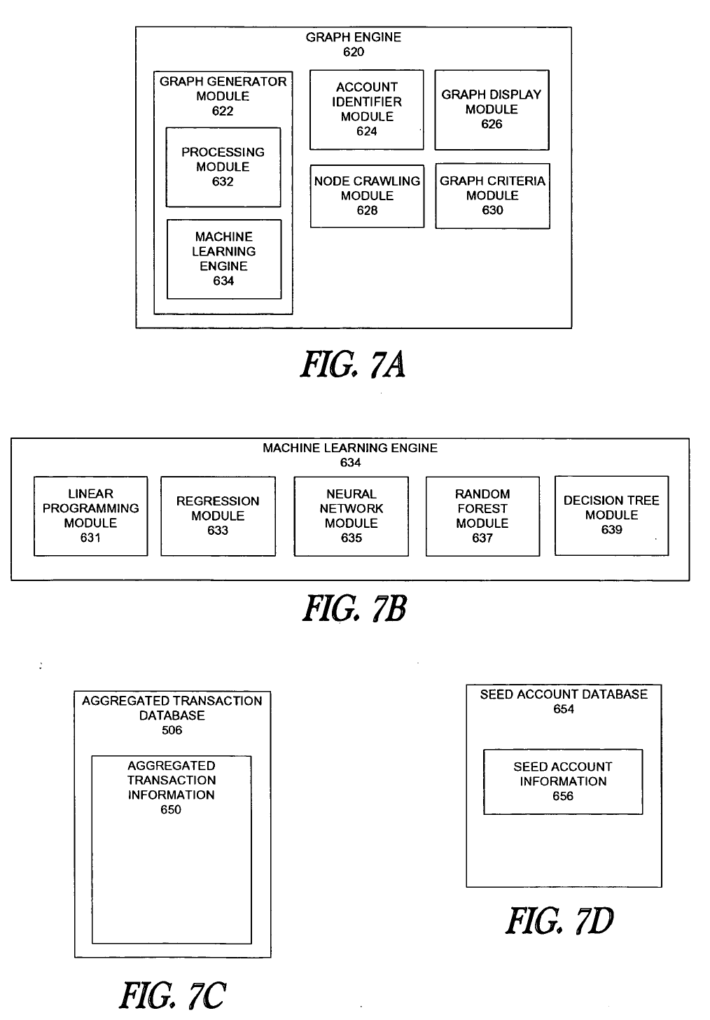

FIG. 7A is a diagram illustrating a graph engine 620, according to an embodiment. The graph engine 620 includes a graph generator module 622, an account identifier module 624, a graph display module 626, a node crawling module 628, and a graph criteria module 630. The account identifier module 624 may identify accounts in the aggregated transaction information that are suspected of fraudulent activity and generates account information (e.g., seed account information) from the aggregated transaction information for each of the suspected accounts. The graph generator module 622 includes a processing module 632 and a machine learning engine 634. The processing module 632 may receive the seed account information for the seed account, identify accounts associated seed account and associations between the accounts, generate a graph including the accounts and their respective associations, generate graph metrics for the graph, generate a score for the graph and store the graph according to the score in a graph queue in a graph repository. The processing module 632 may further identify new activity for a graph, merge graphs, purge a node in a graph, purge an edge in a graph, or purge a graph from the graph repository.

The graph display module 626 may identify an agent from a group of agents, dequeue a graph from the graph queue, and communicate an interface to the agent that includes the graph. The graph display module 626 may further receive graph metadata for a graph from an agent and store the graph metadata with the graph on a graph queue. The graph display module 626 may further identify new activity in a graph that is stored in the graph queue and highlight the new activity in graph.

The node crawling module 628 may be used to crawl the nodes in a graph to identify a status of a node (e.g., account) as “GOOD” or “BAD.”

The graph criteria module 630 may be used to generate graph criteria that are used by the graph engine 620 to generate a score for a graph. The graph criteria module 630 may generate graph criteria based on ratings that are received from agents who rate graphs.

FIG. 7B is a block diagram illustrating a machine learning engine 634, according to an embodiment. The machine learning engine 634 may be used to generate a score for a graph. For example, the machine learning engine 634 analyze the graph metrics for the graph in conjunction with the above mentioned graph criteria to generate a score. In one embodiment, the machine learning engine 634may use one or more modules to perform the analysis. For example, the machine learning engine 634may use a linear programming module 631, a regression module 633, a neural network module 635, a random forest module 637, or a decision tree module 639 to analyze the graph metrics.

FIG. 7C is a block diagram illustrating an aggregated transaction database 506, according to an embodiment. The aggregated transaction database 506 includes aggregated transaction information 650. In one embodiment, the aggregated transaction information 650 may include transaction information communicated from a commerce site 106 (FIG. 2), banking site 206 (FIG. 3), telecom site 306 (FIG. 4) and/or an ISP site 406 (FIG. 5). The aggregated transaction information 650 may include information regarding accounts and associations between the accounts. For example, aggregated transaction information 650 may include information for an account including the name of a person (e.g., legal or natural) that is responsible for the account, a social security number, a credit card number, an email address, a telephone number, an account balance, an address. Further, the aggregated transaction information 650 may include a history of transactions associated with an account.

FIG. 7D is a block diagram illustrating a seed account database 654, according to an embodiment. The seed account database 654 may include seed account information 656 for multiple accounts. The seed account information 656 for a single account may be registered in the seed account database 654 in response to the identification of a suspicious account. For example, the seed account information 656 may be retrieved from the aggregated transaction information 650 shown in FIG. 7C in response to the identification of a suspicious account in the aggregated transaction information 650.

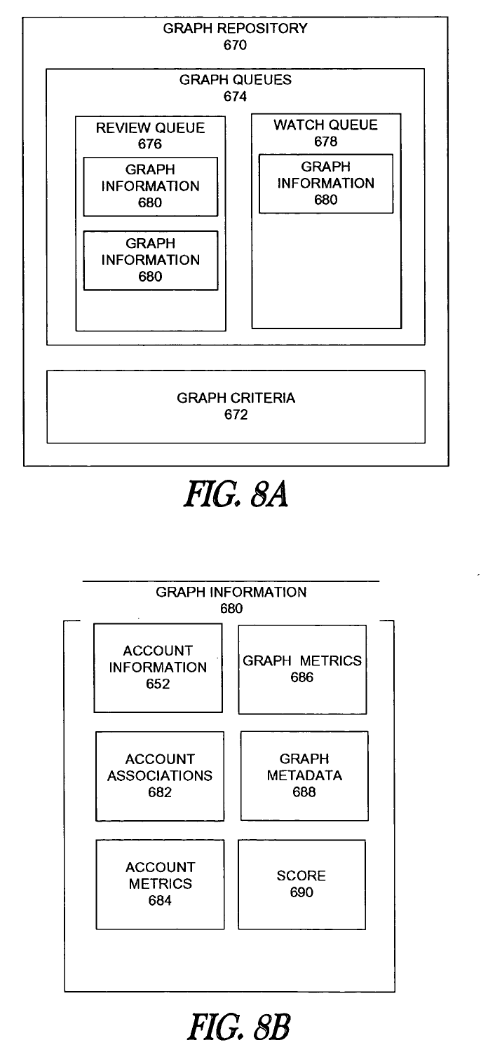

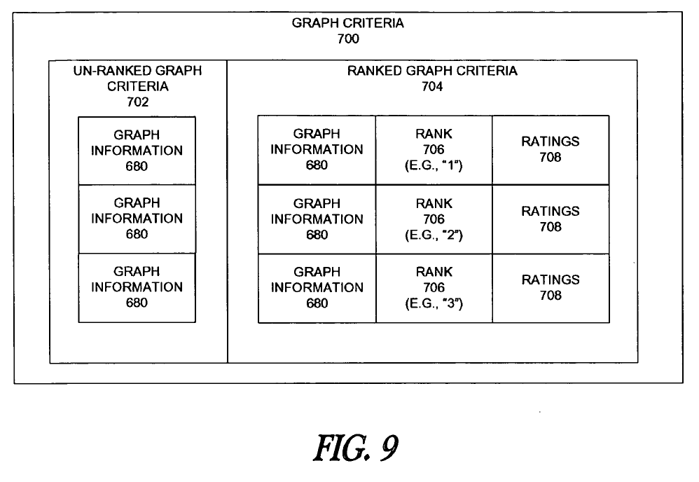

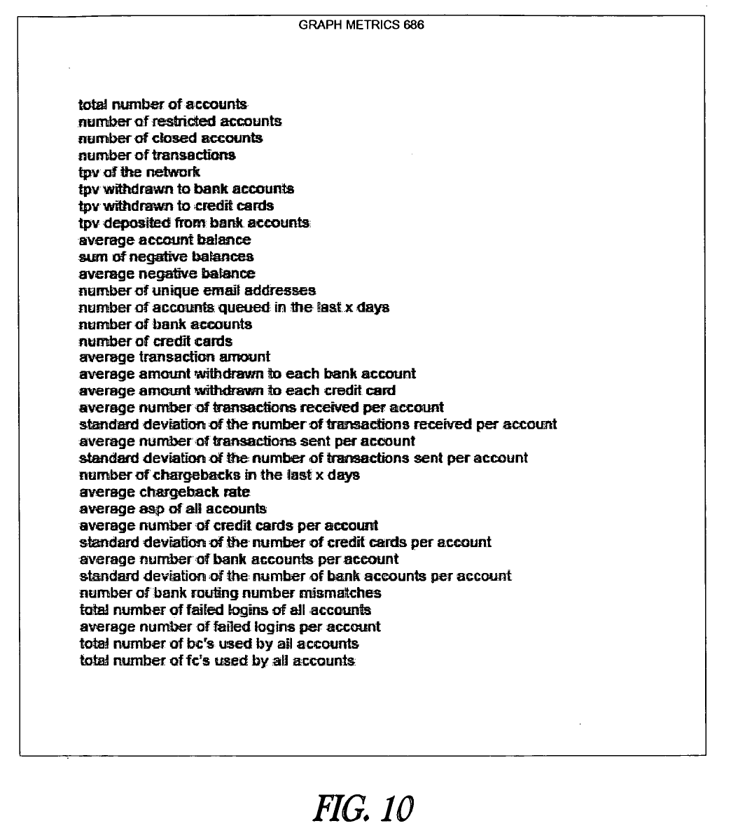

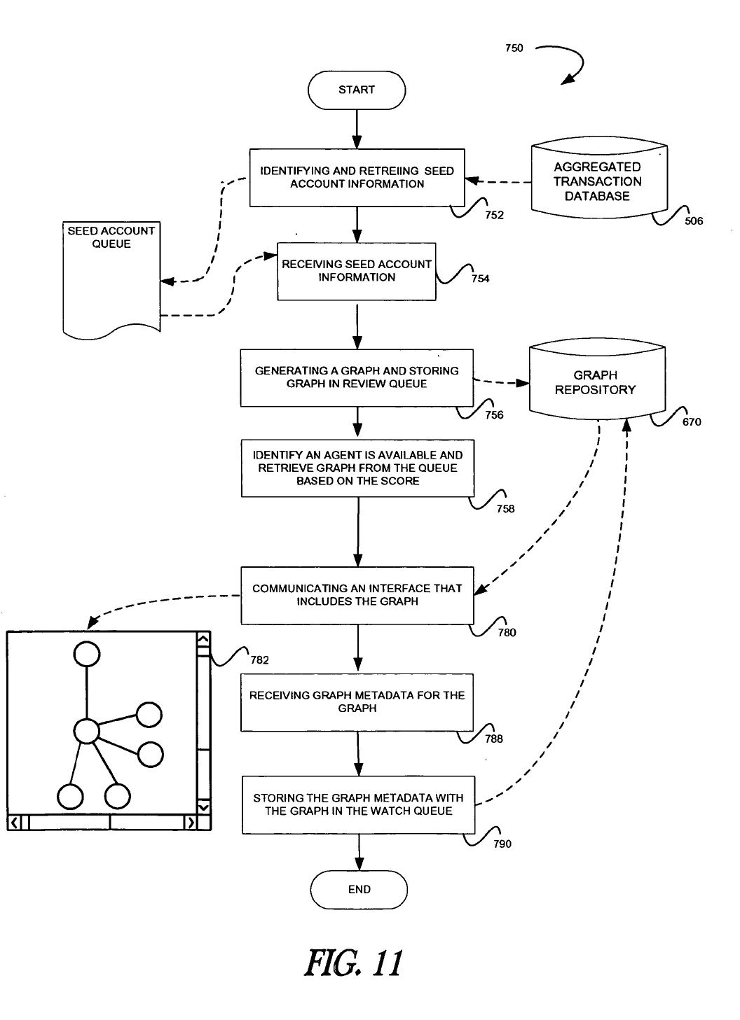

FIG. 8A is a block diagram illustrating a graph repository 670, according to an embodiment. The graph repository 670 stores a graph queues 674 and graph criteria 672. The graph queues 674 includes a review queue 676 and a watch queue 678. The graph queues 674 may be used to store graph information 680. The graph information 680 may be used to render a graph on an interface. The review queue 676 may be used to store graph information 680 for graphs that require review by an agent. In one embodiment, the graphs on the review queue 676 may be arranged according to a score associated with each graph. A high score may indicate a high likelihood of fraudulent activity and a low score may indicate a low likelihood of fraudulent activity. Accordingly, the graphs on the review queue 676 with the highest likelihood of fraudulent activity are at the head of the review queue 676 and the graphs the lowest likelihood of fraudulent activity are at the tail of review queue. The graphs on the review queue 676 are presented to one or more agents for review as the agent becomes available. The watch queue 678 includes graphs that have been reviewed by agents and are being monitored for new activity. Accordingly, a graph on the watch queue 678 may be moved to the review queue 676 in response to the detection of new activity on the graph.

FIG. 8B is a block diagram illustrating graph information 680, according to an embodiment. The graph information 680 may be used to render a graph on an interface. The graph information 680 includes account information 652, account associations 682, account metrics 684, graph metrics 686, graph metadata 688, and a score 690. The account information 652 describes one or more accounts that are respectively represented as nodes on a graph. For example, the account information 652 may include the name of a person (e.g., legal or natural) that is responsible for the account, a social security number, a credit card number, an email address, a telephone number, an account balance, an address. The account associations 682 may include information to render edges that connect the nodes on a graph. The account associations 682 may include a transaction between a pair of nodes (e.g., accounts) or links between a pair of nodes (e.g., accounts). For example, a transaction may be rendered as a directed edge that represents a flow of money or value from one account to another account. Also for example, a link may be rendered as an edge that represents an email address, credit card number, or telephone number that is shared by a pair of accounts (e.g., linked accounts). The account metrics 684 includes information that characterizes a particular account. For example, the account metrics 684 may include the last time the account was accessed, the average number of accesses per month, the average daily balance, etc. The graph metrics 686 may characterize the graph, as described below. The graph metadata 688 may include comments and remarks that are received from an agent that reviews the graph. For example, the graph metadata 688 may include text or numeric information for recall the next time the graph is viewed by the agent. The score 690, in one embodiment, may indicate a likelihood of fraudulent activity. For example, a high score may indicate a high likelihood of fraudulent activity and a low score may indicate a low likelihood of fraudulent activity. In one embodiment the score may be generated by the machine learning engine 634 based on the graph metrics and/or the graph criteria 672, as shown in FIG. 8A.

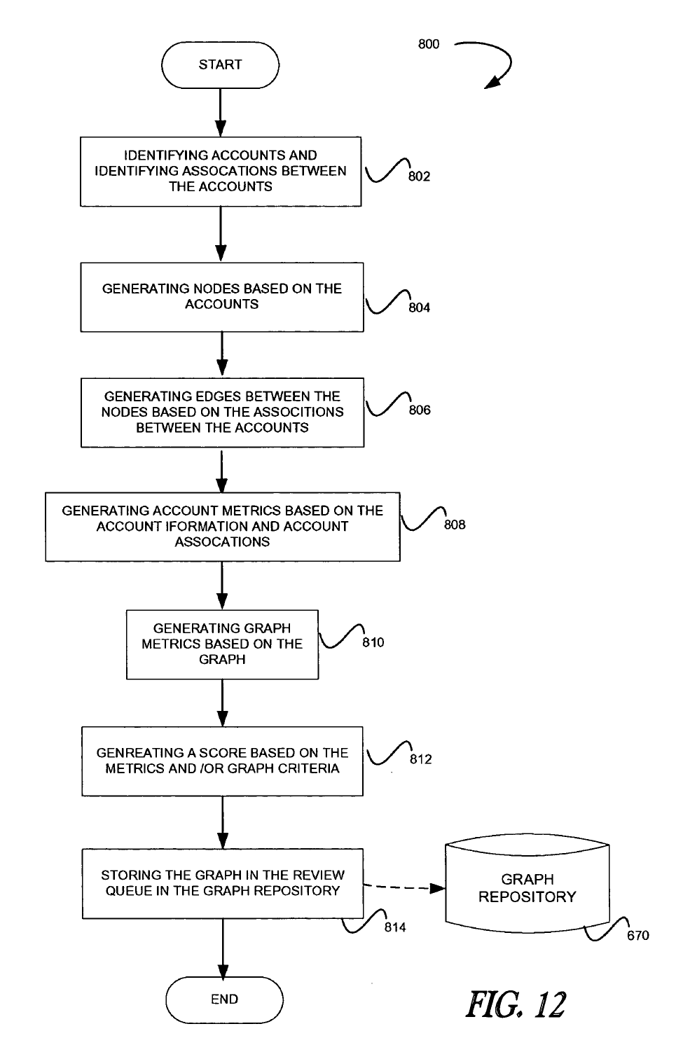

FIG. 9 is a block diagram illustrating graph criteria 700, according to an embodiment. In one embodiment, the graph criteria 700 may be generated from ratings of graphs that are received from agents. In one embodiment, the graph criteria 700 may be used by the machine learning engine 634 shown in FIG. 7B to generate a score 690 shown in FIG. 8B for each graph. The graph criteria 700 may include un-ranked graph criteria 702 and ranked graph criteria 704.

The un-ranked graph criteria 702 may include multiple entries of graph information 680 that respectively correspond to graphs. In one embodiment, the un-ranked graph criteria 702, in its entirety, may be associated with a status of “GOOD.” In another embodiment, the un-ranked graph criteria 702 may be associated with a status of “BAD.” The machine learning engine 634 shown in FIG. 7B may use the graph information 680 included in the un-ranked graph criteria 702 to identify a match. For example, the machine learning engine 634 may identify a graph that is being analyzed as matching any of the graphs in the un-ranked graph criteria 702. Further, the machine learning engine 634 may generate a score 690 shown in FIG. 8B for the graph being analyzed based on the presence of a matching graph in the un-ranked graph criteria 702.

The ranked graph criteria 704 may include graph information 680 for multiple graphs. Each graph includes a rank 706 and ratings 708. The rank 706 of a particular graph may be used to provide a relative measurement with the other graphs in the ranked graph criteria 704. For example, a graph with a rank of “1” may denote a graph that is most likely exhibit fraudulent behavior and a rank 706 of “100” may denote a graph that is least likely to exhibit fraudulent behavior and a rank 706 of “2” to “99” may denote a graph that exhibits fraudulent behavior somewhere between. The rank 706 may be generated based on ratings 708 that are received from agents who rate the graph.

FIG. 10 is a block diagram illustrating graph metrics 686, according to an embodiment. The graph metrics 686 may be generated for a graph and stored with the graph in the graph information 680 shown in FIG. 9. The graph metrics 686 include multiple metrics. Each graph metric 686 may include a number, a payment volume, an average or a standard deviation. A glossary of abbreviations used in the graph metrics 686 appear below:

| Abbreviation | Name | Comment |
|---|---|---|
| TPV | Total | The total amount of money represented with |
| | Payment | directed edges in a graph. |
| | Volume | |
| BC | Browser | Letters, numbers, or an alphanumeric |
| | Cookie | generated by a commerce site 106 (FIG. 2), |
| | | banking site 206 (FIG. 3), a telecom site 306 |
| | | (FIG. 4) or an ISP site 406 (FIG. 5). The |
| | | alphanumeric may be communicated to a |
| | | client computer and contained in a browser |
| | | cookie on the client computer. |
| FC | Flash Cookie | Flash-based letters, numbers, or |
| | | alphanumeric generated by a commerce site |
| | | 106, a banking site 206, a telecom site 306 |
| | | or an ISP site 406. The FSO may be |
| | | communicated to a client computer and |
| | | contained in a browser cookie on the client |
| | | computer. |
| ASP | Average | The average price a merchant sells a |
| | Selling | product or service. |
| | Price | |

### Analyzing Data Using Graphs

FIG. 11 is a block diagram illustrating a method 750, according to an embodiment, to analyze data using graphs. The method 750 commences at operation 752 with the account identifier module 624 shown in FIG. 7A identifying and retrieving account information in the form of seed account information 656 shown in FIG. 7D from the aggregated transaction database 506, as shown in FIG. 7C. The account identifier module 624 may identify the seed account information 656 for an account to further investigate the account in the context of a graph or network. In one embodiment, the account identifier module 624 may use rules to identify the seed account information 656. For example, the account identifier module 624 may use the rules to indentify an account where an attempt to add a credit card to the account fails for the reason that credentials are rejected. In further detail, the aggregated transaction information 650 shown in FIG. 7C in the aggregated transaction database 506 may indicate that the credentials were received from a user that attempted to add the credit card to the account and the credentials were rejected by the credit card company. For example, credentials may include a zip code, a CVV2 code, or a billing address that is rejected. The CVV2 code is a code introduce by credit systems to improve transactions security. The CVV2 may be three-digit value that is printed on the signature panel on the back of credit cards immediately following the card account number. In response to identifying an account, the account identifier module 624 may retrieve the aggregated transaction information 650 from the aggregated transaction database 506 as account information in the form of seed account information 656. In one embodiment the seed account information 656 may be stored in a seed account queue. In another embodiment the seed account information 656 may be stored in the seed account database 654 shown in FIG. 7D.

At operation 754, the processing module 632 in the graph generator module 622 both shown in FIG. 7A may receive the seed account information 656. For example, the graph generator module 622 may receive the seed account information 656 by retrieving the seed account information 656. In another embodiment, the graph generator module 622 may receive the seed account information 656 by retrieving the seed account information 656 from the seed account database 654.

At operation 756 the processing module 632 may generate the graph and store the graph in a review queue, as described in further detail in the method 800 as illustrated in FIG. 12. Salient operations include the processing module 632 generating the graph, generating a score for the graph, and storing the graph in a review queue according to the score of the graph. In one embodiment, the graph may be stored in a review queue in the graph repository 670. In another embodiment, the graph may be stored in a review queue in memory.

At operation 758, the graph display module 626 shown in FIG. 7A may identify an available agent. For example, multiple agents may be reviewing graphs and one agent may become available. The graph display module 626 may identify the available agent from the multiple agents and responsive to the identification retrieve a graph from the head of the review queue 676. In one embodiment, the graphs may retrieve from head of the review queue 676 as graph information 680 both shown in FIG. 8A. At operation 780, the graph display module 626 renders the graph information 680 as a graph on an interface 782 and communicates the interface 782 to the agent.

Next, the agent may analyze the graph on the interface 782 to identify characteristics or traits of the graph that are recorded in the form of graph metadata 688 shown in FIG. 8B (e.g., text, numeric information, etc.). For example, at operation 788, the graph display module 626 may receive the graph metadata 688 from the agent and, at operation 790, the graph display module 626 may store the graph metadata 688 in the graph information 680 for the graph on a watch queue 678 shown in FIG. 8A. For example, the graph may be stored on the watch queue 678 as graph information 680 until further activity is associated with graph. In response to identifying further activity, the processing module 632 may move the graph to the review queue 676 for review by an available agent.

FIG. 12 is a block diagram illustrating a method 800, according to an embodiment, to generate and store a graph. The method 800 corresponds to the operation 756 on FIG. 11.

The method 800 commences at operation 802 with the processing module 632 shown in FIG. 7A identifying accounts and associations between the accounts. For example, the processing module 632 may search the aggregated transaction information 650 shown in FIG. 7C to identify accounts that are linked with the seed account and/or to identify accounts that have participated in transactions with the seed account. The processing module 632 may iterate this process until nodes are added to the graph a predetermined number of levels deep. For example, the processing module 632 may identify a first level of accounts that have links or transactions with the seed account and a second level of accounts that have links or transactions with accounts in the first level. In one embodiment, the processing module 632 may store the aggregated transaction information 650 as account information 652 in the graph information 680. Further, the processing module 632 may store the aggregated transaction information 650 as account associations 682 in the graph information 680 shown in FIG. 8A.

At operation 804, the processing module 632 may generate nodes for the graph based on the account information 652 shown in FIG. 8B and, at operation 806, the processing module 632 may generate edges that connect the nodes in the graph based on the account associations 682 shown in FIG. 8B. At operation 808, the processing module 632 may generate account metrics 664 shown in FIG. 8B based on the account information 652 and the account associations 682. At operation 810, the processing module may generate graph metrics 686 based on the graph. For example, the processing module may generate a graph metric 686 in the form of a number, a payment volume, an average or a standard deviation, as shown in FIG. 10 The graph metrics 686 may characterize the graph. For example, the graph metrics 686 may include a total number of accounts (e.g., nodes), a number of restricted accounts, a number of closed accounts, etc. Further, for example, a standard deviation may be generated based graph metrics 686 that have been collected for multiple substantially similar graphs for a predetermined period of time (e.g., day, week, month).

At operation 812 the machine learning engine 634 shown in FIG. 7B may generate a score 690 for the graph based on the graph metrics 686 and the graph criteria 672 shown in FIG. 8A. For example, the machine learning engine 634 may execute as one or more modules including a linear programming module 631, a regression module 633, a neural network module 635, a random forest module 637 or a decision tree module 639 all shown in FIG. 7B to generate the score 690. In one embodiment, the one or more modules may use the standard deviation 724 in the graph metrics 686 for the graph to generate the score 690. Further, the one or more modules may utilize the the un-ranked graph criteria or the ranked graph criteria 704 shown in FIG. 9 to generate a score 690 for the graph. For example, the machine learning engine 634 may identify the generated graph as matching a graph in the un-ranked graph criteria or a graph the ranked graph criteria 704. In one embodiment, the machine learning engine 634 may generate a score 690 for the graph based on the score 690 of the matching graph in the un-ranked graph criteria or the ranked graph criteria 704.

At operation 814 the graph display module 626 shown in FIG. 7A may store the graph in the review queue 676 shown in FIG. 8A in the graph repository 670 and the process ends. For example, the graph may be threaded into the review queue 676 such that the scores of the respective graphs in the review queue 676 increase in value. In another embodiment the scores of the graphs in the review queue 676 may decrease in value. In another embodiment, the review queue 676 may reside in memory.

### Merging Graphs

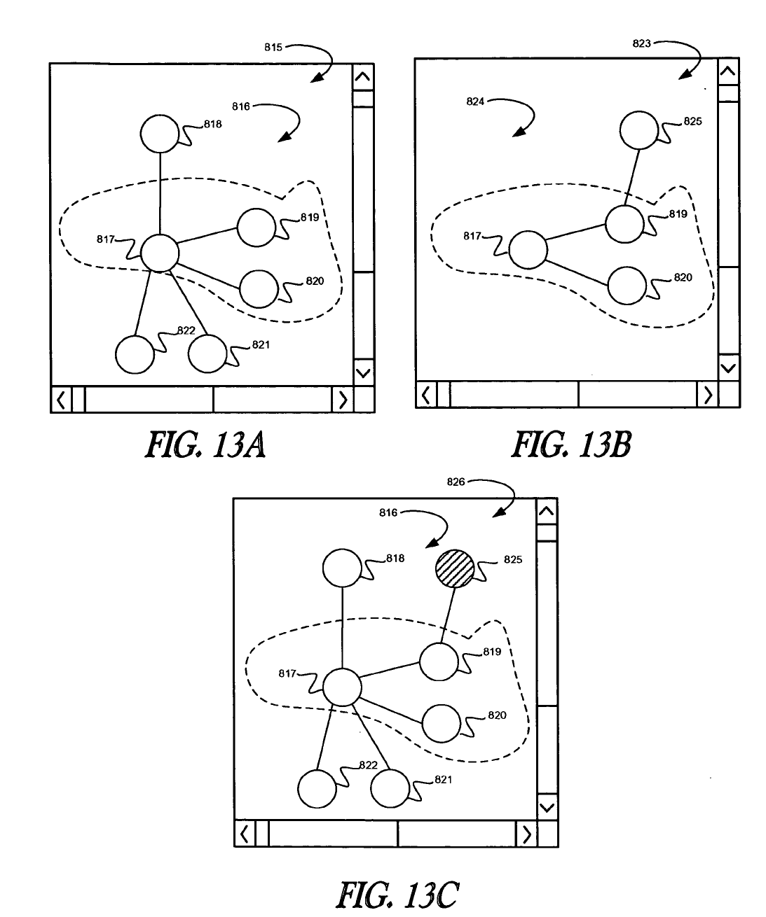

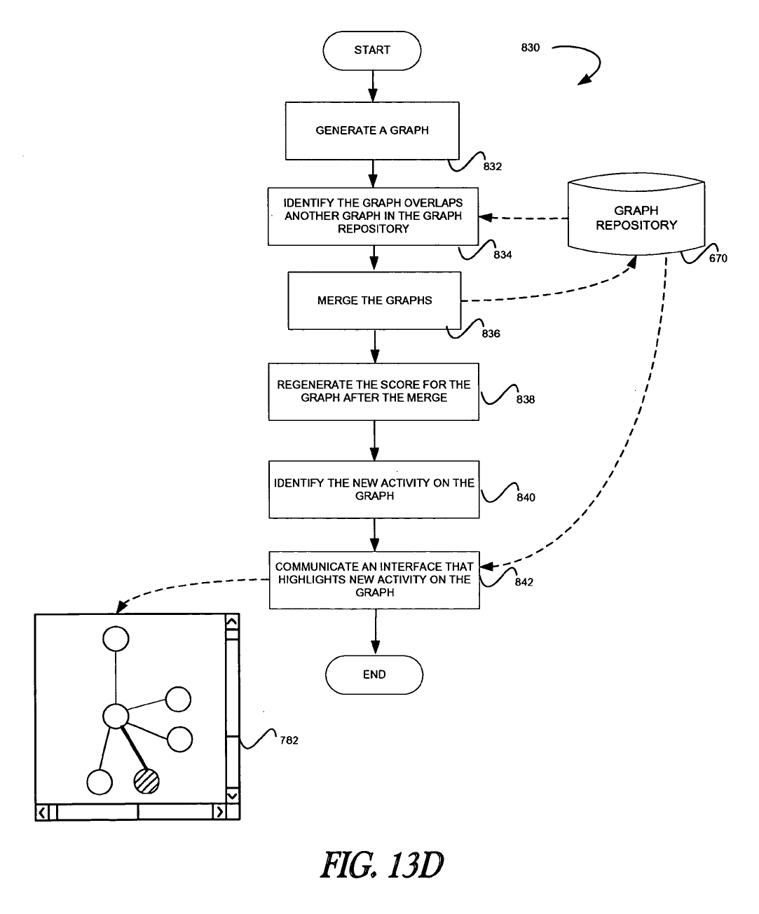

FIG. 13A is a diagram illustrating an interface 815, according to an embodiment, that depicts a graph 816. The graph 816 is shown to include the nodes 817, 818, 819, 820, 821 and 822. In one embodiment, the node 817 may represent a seed account for the graph 816 and the edges connecting the node 817 with the nodes 818, 819, 820, 821 and 822 may represent account associations 682 in the form of transactions or links between the nodes.

FIG. 13B is a diagram illustrating an interface 823, according to an embodiment, that depicts a graph 824. The graph 824 includes the nodes 817, 819, 820 and 825. The nodes 817, 819, and 820 are circled to identify them as common to the graph 816, shown in FIG. 13A.

FIG. 13C is a diagram illustrating an interface 826, according to an embodiment, that depicts a merger of graphs. The interface 826 includes a merger of the graph 816, shown in FIG. 13A, and the graph 824, shown in FIG. 13B. For example, the graph 824 is merged into the graph 816, shown in FIG. 13C. The graph 816 further illustrates the highlighting of node 825. In one embodiment, the highlighting of the node 825 may indicate new activity in the graph 816 to an agent. For example, the highlighting of the node 825 may indicate the node 825 has been added to the graph 816. Also for example, highlighting may include color coding an edge or expanding the width of an edge.

FIG. 13D is a block diagram illustrating a method 830, according to an embodiment, to merge graphs. The method 830 commences at operation 832 with the graph engine 620 shown in FIG. 7A generating a graph, as previously described in the operations 752, 754, and 756 on FIG. 11.

At operation 834, the processing module 632 shown in FIG. 7A identifies the graph generated in operation 832 as overlapping a graph that is stored in the graph repository 670. For example, the processing module 632 may identify that one or more of the accounts represented in the generated graph are already included in a graph that is stored in the graph repository 670. At operation 836, the processing module 632 merges the graphs. For example, the processing module 632 may generate the graph information 680 shown in FIG. 8A such that each the account is represented as a single node in the merged graph.

At operation 838, the machine learning engine 634 shown in FIG. 7B regenerates the score 690 for the merged graph and stores the score 690 shown in FIG. 8B in the graph information 680.

At operation 840, the processing module 632 identifies the new activity in the graph. At operation 842, the graph display module 626 may communicate an interface 782 shown in FIG. 11 that includes the graph to an agent. The graph is highlighted. For example, new activity in the form of additional transactions, nodes or links, may be highlighted on the graph. Also for example, transactions that are risky may be highlighted on the graph.

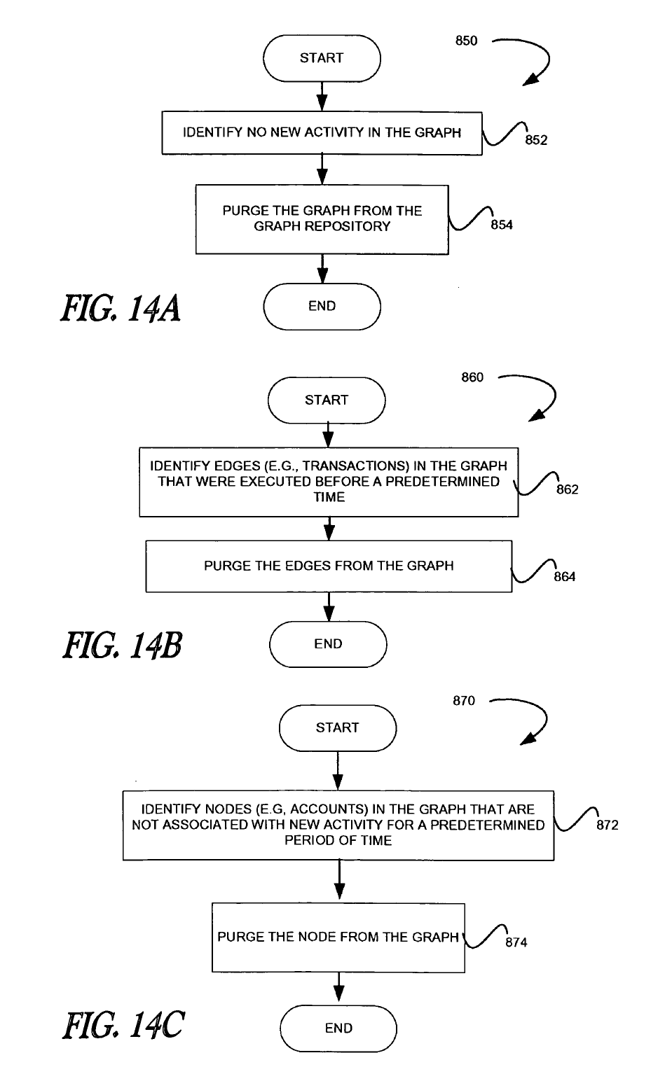

FIG. 14A is a block diagram illustrating a method 850, according to an embodiment, to purge a graph. Purging graphs may be advantageous to the storage requirements for the graphs. The method 850 commences at operation 852 with the processing module 632 shown in FIG. 7A identifying no new activity for a graph on the graph queues 674 shown in FIG. 8A. For example, the processing module 632 may identify a graph on the watch queue 678 shown in FIG. 8A that has been reviewed by an agent but without new activity for a predetermined period of time. In another embodiment, the processing module 632 may identify a graph on the review queue 676 shown in FIG. 8A that has not been reviewed by an agent but nevertheless has been without new activity for a predetermined period of time. At operation 854, the processing module 632 may purge the graph from the graph repository 670 shown in FIG. 8A and the process ends.

FIG. 14B is a block diagram illustrating a method 860, according to an embodiment, to purge an edge from a graph. The method 860 may be used to maintain relevance for an agent who is tasked with reviewing the graph and further to limit the storage requirements for the edge(s) (e.g., transactions, links). The method 860 commences at operation 862 with the processing module 632 identifying transactions in the graph that were executed before a predetermined period of time. At operation 864, the processing module 632 purges the edges (e.g., transactions, links) from the graph and the process ends. For example, the processing module 632 may purge the account associations 682 for the purged edges(s).

FIG. 14C is a block diagram illustrating a method 870, according to an embodiment, to purge a node from a graph. The method 870 may be used to maintain relevance for an agent who is tasked with reviewing the graph and further to free the resources used to store the node(s) (e.g., accounts) in the graph. The method 870 commences at operation 872 with the processing module 632 identifying nodes (e.g., accounts) in the graph that are not associated with new activity for a predetermined period of time. At operation 874, the processing module 632 purges the nodes from the graph and the process ends. For example, the processing module 632 may purge the account information 652 shown in FIG. 8B for the purged nodes.

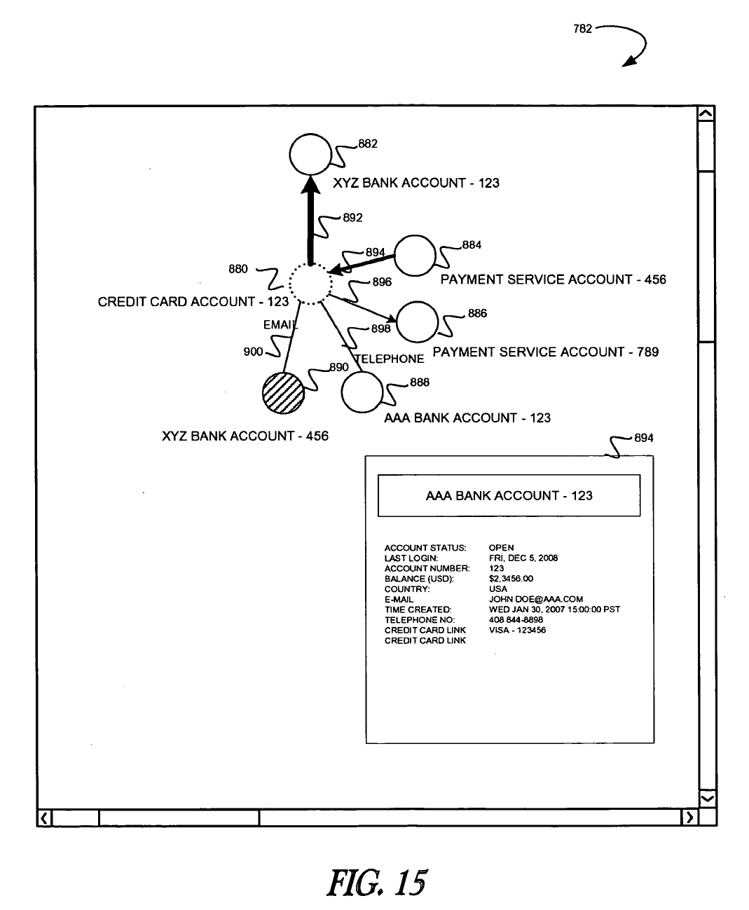

FIG. 15 is a diagram illustrating an interface 782, according to an embodiment, that includes a graph. The graph includes the nodes 880, 882, 884, 886, 888, and 890. The node 880 represents a seed account in the form of a credit card account with an account number of “123.” The nodes 882, 884, 886, 888, and 890 are one level deep from the seed account. Other graphs may include multiple levels of nodes. The node 882 represents a first “XYZ Bank Account” with an account number of “123.” The node 884 represents a first “Payment Service Account” with an account number of “456.” The node 886 represents a second “Payment Service Account” with an account number of “789.” The node 888 represents a “AAA Bank Account” with an account number of “123.” The node 890 represents a second “XYZ Bank Account” with an account number of “456.” The node 890 is shown as highlighted indicating to an agent that the node 890 was added to the graph subsequent to the agents review.

The node 880 is connected to the other nodes with edges 892, 894, 896, 898, and 900. The edges 892, 894, and 896 are directed edges and represent transactions. For example, the edge 892 represents a flow of money from the node 880 to node 882. The width of the edge visually highlights a greater amount of money in comparison with the edges 894 and 896. For example, the edge 892 may represent a transfer of $100.00 USD. Further for example, the edge 894 represents a flow of money from the node 884 to the node 880. The width of the edge visually highlights a lesser amount of money in comparison with the edge 892. For example, the edge 894 may represent a transfer of $50.00 USD. The edge 896 represents a flow of money from the node 880 to the node 886. The width of the edge visually highlights a lesser amount of money in comparison with the edge 892 and the edge 894. For example, the edge 896 may represent a transfer of $25.00 USD. The edge 898 and 900 represent links that respectively connect the node 880 the nodes 890 and 888. For example, the edge 898 represents a telephone link because the accounts represented by the nodes 880 and the node 888 include the same telephone number. Also for example, the edge 900 represents an email link because the accounts represented by the node 880 and the node 890 include the same email address. The interface 782 shown in FIG. 11 further includes a node information box 894 that is displayed in response to selecting the node 888. The node information box 894 includes account information 652 shown in FIG. 8B including an account status, a last login date, an account number, an account balance, an account country, an email address, etc.

### Crawling Graphs

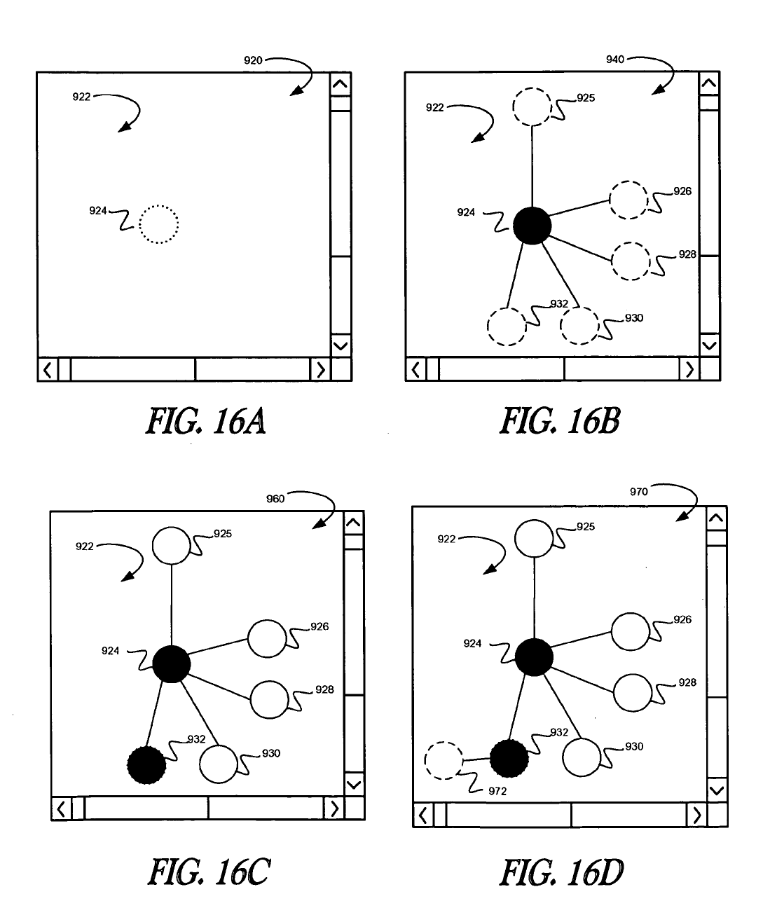

FIG. 16A is a diagram illustrating an interface 920, according to an embodiment. The interface 920 includes the graph 922. The graph 922 is shown to include the node 924. In one embodiment, the node 924 may represent a seed account for the graph 922. The graph 922 is represented from the point of view of the node crawling module 628 shown in FIG. 7A. Accordingly, the graph 922 may include additional nodes; however, as illustrated in the FIG. 16A, the node crawling module 628 has presently indentified only the node 924 in the graph 922. The broken circumference for the node 924 represents the node crawling module 628 as identifying whether the status of the node 924 is “GOOD” or “BAD” (e.g., pathological, fraudulent, anomalous, etc.). In one embodiment, the node crawling module 628 may use account metrics 684 shown in FIG. 8B for the node 924 to identify the status of the node 924. In one embodiment, the account metrics 684 for the node 924 may include standard deviation data. In one embodiment, the node crawling module 628 may compare the standard deviation data for the node 924 with standard deviation data that is generated from other accounts in substantially similar graphs. A standard deviation is a measure of the dispersion. The node crawling module 628 may identify whether the standard deviation that corresponds to a particular account metric 684 for the graph 922 is different than the standard deviation for the same account metric 684 that is generated from other accounts in substantially similar graphs. Accordingly, in one embodiment, the node crawling module 628 may identify the status (e.g., “GOOD” or “BAD”) of a node (e.g., account) based on a difference in the standard deviation data that is greater than a predetermined threshold.

FIG. 16B is a diagram illustrating an interface 940, according to an embodiment. The interface 940 includes the graph 922 which corresponds to the graph 922 shown in FIG. 16A and, accordingly, the same or similar references have been used to indicate the same or similar features unless otherwise indicated. The node 924 is solid black to represent the node crawling module 628 shown in FIG. 7A as having identified the node 924 with a status of “BAD.” In response to identifying the node 924 as “BAD,” the node crawling module 628 may identify edges connected to the node 924 and crawl the edges to discover the nodes 925, 926, 928, 930 and 932. The edges may represent transactions and/or links, as previously described. The broken circumference for the nodes 925, 926, 928, 930 and 932 may represent the node crawling module 628 as identifying the status of the respective nodes 925, 926, 928, 930 and 932, as being “GOOD” or “BAD.”

FIG. 16C is a diagram illustrating an interface 960, according to an embodiment. The interface 960 includes the graph 922 which corresponds to the graph 922 in FIGS. 16A and 16B and, accordingly, the same or similar references have been used to indicate the same or similar features unless otherwise indicated. The interface 960 illustrates the nodes 924, 926, 928, 930 and 932 as circles with solid circumferences to indicate the node crawling module 628 shown in FIG. 7A as having identified the nodes 925, 926, 928, 930 and 932 with a status of “GOOD.” In contrast, the node 932 is solid black to represent the node crawling module 628 as having identified the node 932 with a status of “BAD.”

FIG. 16D is a diagram illustrating an interface 970, according to an embodiment. The interface 970 includes the graph 922 which corresponds to the graph 922 shown in FIG. 16A, 16B, and 16C and, accordingly, the same or similar references have been used to indicate the same or similar features unless otherwise indicated. In response to identifying the node 932 as “BAD,” the node crawling module 628 shown in FIG. 7A identifies an edge leading from the node 932 and crawls the edge to discover the node 972. The edge may represent a transaction or a link, as previously described. The broken circumference for the node 972 represents the node crawling module 628 as identifying the status of the node 972, as previously described. The interface 970 further illustrates that the node crawling module 628 has not identified crawled edges that respectively lead from the nodes 925, 926, 928, or 930 towards a node other than the node 924. For example, in one embodiment, in response to identifying the status of the nodes 925, 926, 928, or 930 as “GOOD,” the node crawling module 628 is blocked from crawling an edge leading from the nodes 925, 926, 928, or 930 that leads to a node other than the node 924.

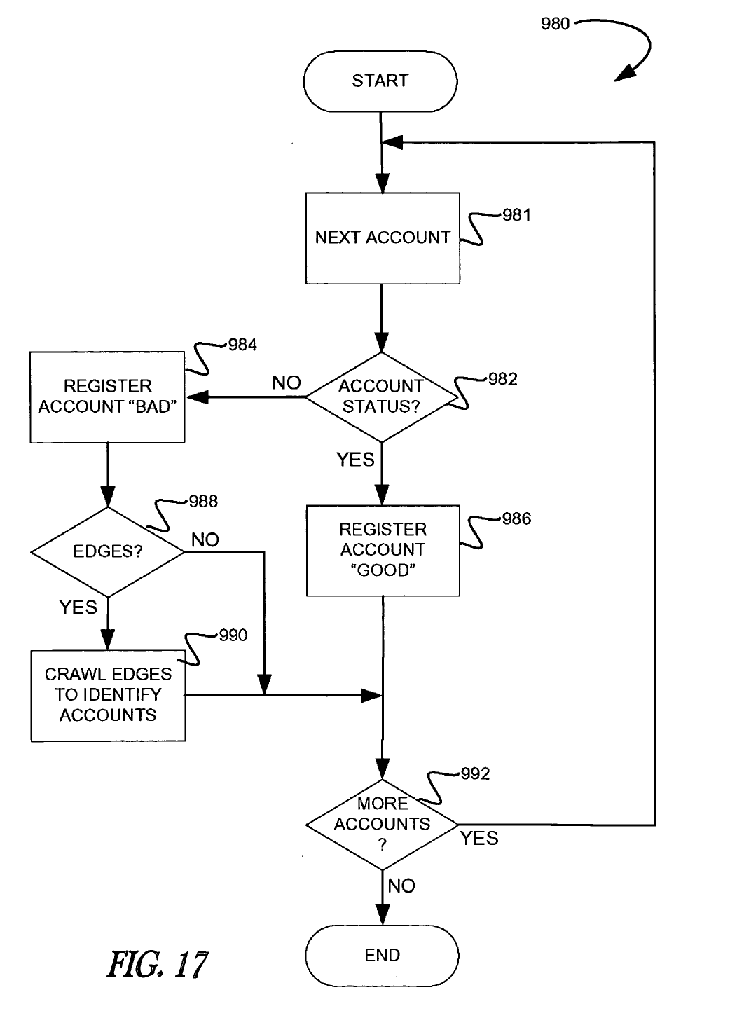

FIG. 17 is a block diagram illustrating a method 980, according to an embodiment, to crawl a graph. The method 980 commences at operation 981 with the node crawling module 628, as shown in FIG. 7A, identifying the next node (e.g., account) in the graph. At decision operation 982, the node crawling module 628 identifies whether the status of a node (e.g., account) is “GOOD” or “BAD.” In one embodiment, the node crawling module 628 may use account metrics 684 shown in FIG. 8B that includes standard deviation data, as previously described. If the node crawling module 628 identifies the status of the node as “GOOD,” then a branch is made to operation 986. Otherwise a branch is made to operation 984.

At operation 984, the node crawling module 628 registers the status of the node as “BAD” and, at operation 986, the node crawling module 628 registers the status of the account as “GOOD.”

At operation 988, the node crawling module 628 identifies whether the node identified as “BAD” is connected to edges that have not been crawled. If the edges are identified then a branch is made to operation 990. Otherwise a branch is made to decision operation 992. At operation 990, the node crawling module 628 crawls the edge to discover a node.

At decision operation 992, the node crawling module 628 identifies whether more nodes (e.g., accounts) have been identified in the graph that have yet to be identified with a status of “GOOD” or “BAD.”

### Rating Graphs

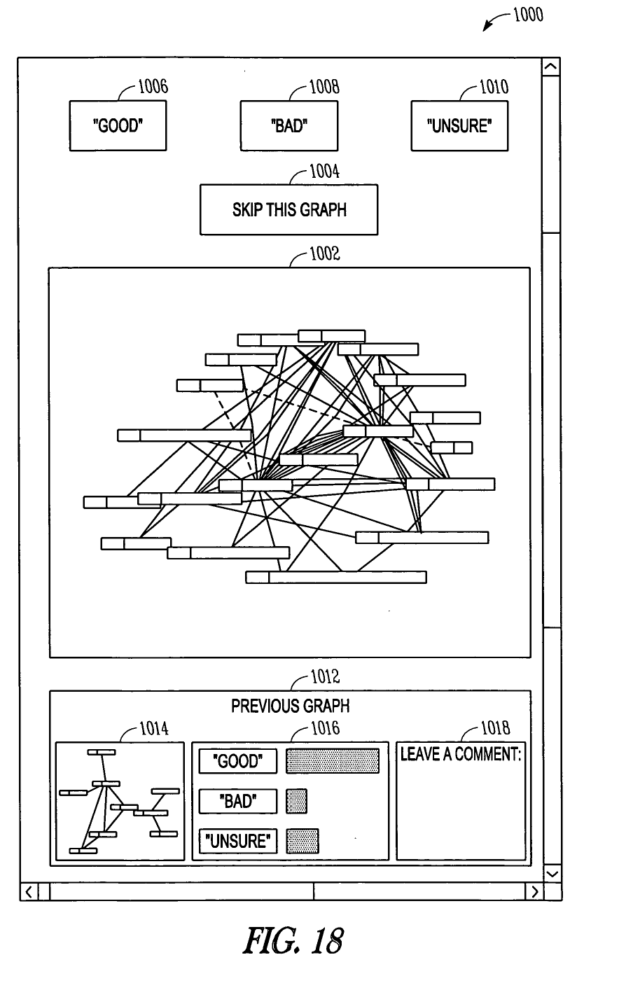

FIG. 18 is an illustration of an interface 1000, according to an embodiment, to rate a graph. For example, the interface 1000 may be used by an agent who rates a graph as predictive or not predictive of fraudulent activity. The graph may be generated according to the methodology illustrated in FIG. 11. In one embodiment, the graph engine 620 shown in FIG. 7A may receive from an agent a rating of “GOOD,” which is indicative of a graph that is not predictive of fraudulent activity, or “BAD,” which is indicative of a graph that is predictive of fraudulent activity, or “UNSURE,” which is indicative of the agent being unsure whether the graph is indicative or not of fraudulent activity.

The middle portion of the interface 1000 includes a graph 1002. The graph 1002 is shown to include nodes and edges connecting the nodes, as previously described.

The top portion of the interface 1000 may include controls including user interface controls 1004, 1006, 1008 and 1010. The user interface control 1004 may be selected to skip to the next graph. The user interface control 1006 may be selected to rate the graph 1002 as “GOOD.” The user interface control 1008 may be selected to rate the graph 1002 as “BAD.” The user interface control 1010 may be selected to rate the graph 1002 as “UNSURE”

The bottom portion of the interface 1000 includes a user interface panel 1012 that includes information regarding the previous graph. The agent may use the user interface panel 1012 to understand how other agents rated the previous graph. The user interface panel 1012 includes a presentation of a graph 1014 that was previously presented and rated by the agent. The user interface panel 1012 further includes histogram information 1016. The histogram information 1016 includes a summary of the ratings that have been received from other agents for the previous graph. Other embodiments may use other representations including a pie chart, numerical information, a chart, etc. The histogram information 1016 includes three bars that are representative of the ratings received from agents who rated the previous graph 1014. The agent may use the user interface panel 1012 to compare his or her rating of the graph 1014 with the ratings received from other agents. The agent may further use an input box 1018 to leave a comment regarding the graph 1014.

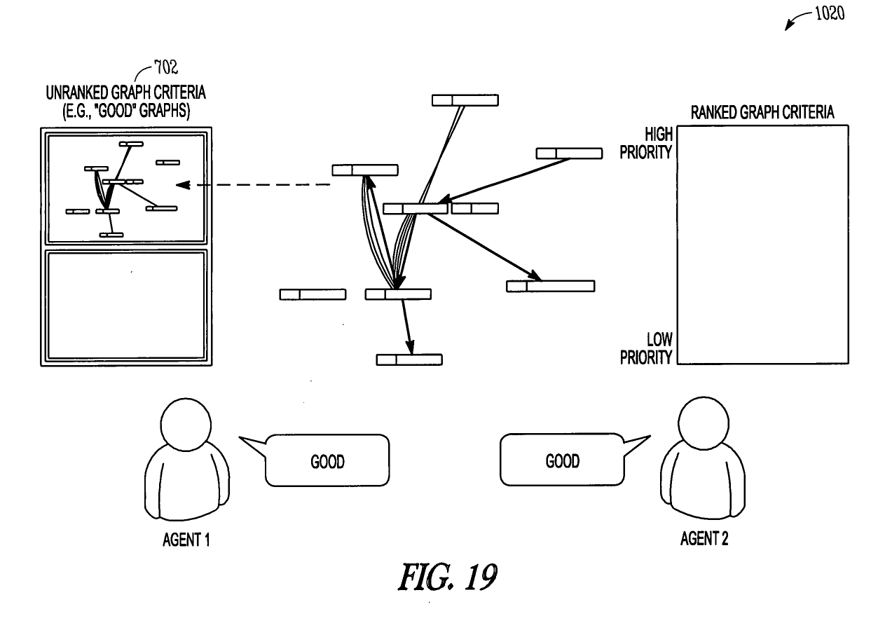

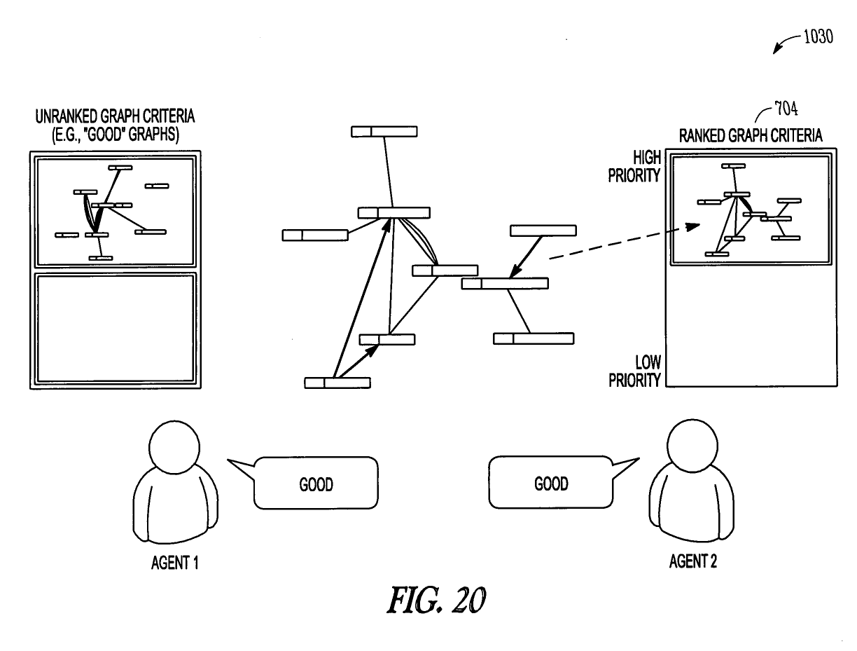

FIG. 19 is a diagram illustrating a concept 1020, according to an embodiment, to generate un-ranked graph criteria 702. The concept 1020 may include one or more agents that may use the interface 1000 shown in FIG. 18 to rate a graph as “GOOD.” Responsive to a unanimous rating of “GOOD,” the un-ranked graph criteria 702 may be generated. For example, the un-ranked graph criteria 702 may be generated to include the graph and an associated rating of “GOOD.” Other embodiments may include other ratings.

FIG. 20 is a diagram illustrating a concept 1030, according to an embodiment, to generate ranked graph criteria 704. The concept 1030 may include one or more agents that may use the interface 1000 shown in FIG. 18 to provide the same or different ratings of the same graph. The concept 1030 illustrates one agent who may rate the graph as “GOOD,” another agent may rate the graph as “UNSURE,” and another agent may rate the graph as “BAD.” Responsive to receiving the ratings, the ranked graph criteria 704 may be generated. For example, the ranked graph criteria 704 may be generated to include the graph and an associated ranking. For example, the ranking of the graph may be “1”.

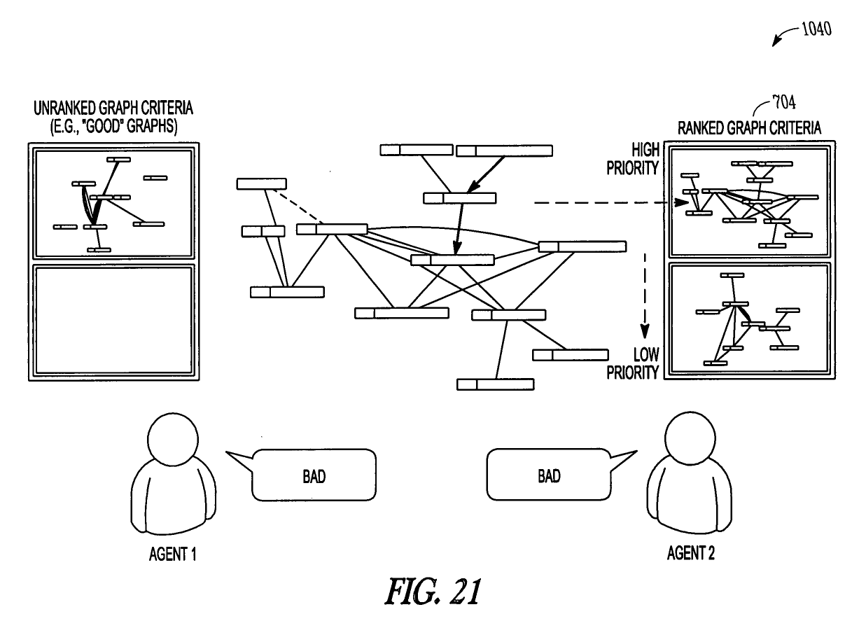

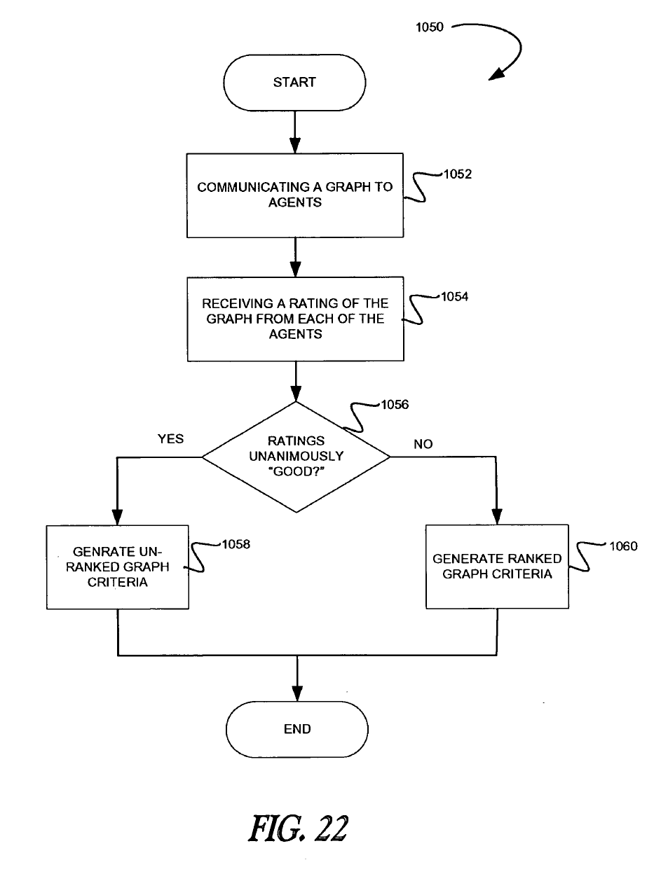

FIG. 21 is a diagram illustrating a concept 1040, according to an embodiment, to insert ranked graph criteria 704. The concept 1040 may include one or more agents that that may use the interface 1000 shown in FIG. 18 to provide the same or different ratings of the same graph, as previously described. In one embodiment, the graph may be inserted into the ranked graph criteria 704 according to the ratings 708 shown in FIG. 9 received from the agents. In one embodiment, the insertion of the new graph into the ranked graph criteria 704 may determine the rank 706 shown in FIG. 9 of the inserted graph and cause a change in the rank 706 of the previously inserted graphs. For example, the present graph is ranked “1” based on two ratings of “BAD” and “BAD.” In contrast, the previously ranked graph, which received a rating of “GOOD” and “UNSURE,” is pushed down towards a “Low Priority” with a new rating of “2.”

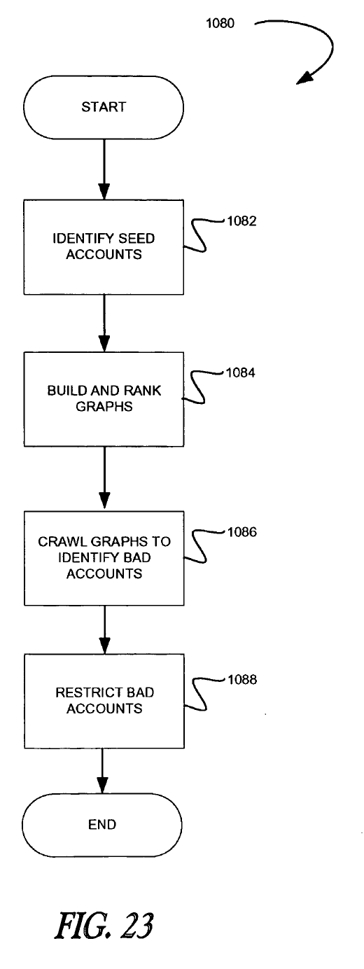

FIG. 22 is a block diagram of a method 1050, according to an embodiment, to generate graph criteria 700 shown in FIG. 9. The method 1050 commences at operation 1052 with the graph engine 620 shown in FIG. 7A communicating the same graph to multiple agents.

At operation 1054, the graph criteria module 630 shown in FIG. 7A may receive, via the interface 1000 shown in FIG. 18, ratings from the agents. In one embodiment, the rating may include “GOOD,” “BAD,” and “UNSURE.” The rating may be an assessment as to whether the agent believes the graph is indicative of fraud, as previously described. At decision operation 1056, the graph criteria module 630 may identify whether the ratings of all of the agents are unanimous. For example, the graph criteria module 630 may identify whether the ratings of all of the agents are “GOOD.” If the graph criteria module 630 identifies all of the ratings received from the agents are “GOOD” then processing continues at operation 1058. Otherwise, processing continues at operation 1060.

At operation 1058, the graph criteria module 630 may generate and store un-ranked graph criteria 702 shown in FIG. 9 based on the ratings. For example, the graph criteria module 630 may generate a status of “GOOD” for the graph by storing the graph as graph information 680 shown in FIG. 9 in any position in the un-ranked graph criteria 702.

At operation 1060, the graph criteria module 630 may generate and store ranked graph criteria 704 shown in FIG. 9. In one embodiment, the graph criteria module 630 may generate a rank for the graph by storing the graph into the ranked graph criteria 704 according to the ratings 708 shown in FIG. 9 for the graph. In one embodiment, the rank may be a value from “1” to “N.” Further, the graph criteria module 630 may store the graph as graph information 680 in the ranked graph criteria 704 with the rank 706 and the ratings 708 received from the agent.

### Restricting Accounts

FIG. 23 is a block diagram of a method 1080, according to an embodiment, to restrict accounts. The method 1080 commences at operation 1082 with an identification of seed accounts. In one embodiment, an agent may manually identify seed accounts that are suspected of fraudulent activity. In another embodiment, the graph engine 620 shown in FIG. 7B may identify a seed account based on an account metric 684 shown in FIG. 8B associated with an account. For example, the account metric 684 may indicate an unusual purchase, unusual amount of purchase, or an unusual location of purchase.

At operation 1084, the graph engine 620 uses the seed accounts to build the graphs and store the graphs as graph information 680 shown in FIG. 8A in the review queue 676, as previously described in FIG. 8A. For example, the graph engine 620 may build a graph based on the seed accounts, as previously described, and store the graphs from most likely to least likely to exhibit fraud in the review queue 676. In one embodiment, the graph engine 620 may uses the un-ranked graph criteria 702 and/or the ranked graph criteria 704 both shown in FIG. 9 to generate a score 690 for the graph.

At operation 1086, the node crawling module 628 shown in FIG. 7A may crawl the nodes in the graphs in the review queue 676. For example, the node crawling module 628 may crawl the graphs according to an order beginning first with the graph at the head of the review queue 676 that is ranked most likely to exhibit fraud and ending with the graph that is at the end of the review queue 676 that is ranked least likely to exhibit fraud. Accordingly, the node crawling module 628 has the advantage of analyzing the graphs in an order that minimizes a loss of resources due to fraudulent activity. The node crawling module 628 may identify accounts with a status of “GOOD” and accounts with a status of “BAD,” as previously described.

At operation 1088, an agent may review the “BAD” accounts to identify accounts that are restricted from further activity or to identify accounts that are suspended from activity. In another embodiment, the graph engine 620 may automatically restrict an account based on a predetermined threshold. Accordingly, the above method has the benefit of affording an identification and restriction of an account in an order that minimizes a loss of resources due to fraudulent activity.

### Example Storage

Some embodiments may include the various databases (e.g., 107, 207, 307, 407, and 506) shown in FIG. 5 being relational databases or in some cases On-Line Analytical Processing (OLAP) based databases. In the case of relational databases, various tables of data are created and data is inserted into, and/or selected from, these tables using SQL, or some other database-query language known in the art. In the case of OLAP databases, one or more multi-dimensional cubes or hypercubes containing multidimensional data from which data is selected from or inserted into using MDX may be implemented. In the case of a database using tables and SQL, a database application such as, for example, MYSQL™, SQLSERVER™, Oracle 8I™, 10G™, or some other suitable database application may be used to manage the data. In this case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. These tables or cubes made up of tables, in the case of, for example, ROLAP, are organized into a RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization, optimization algorithm known in the art.

### A Three-Tier Architecture

In some embodiments, a method is illustrated as implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier, and/or to a backend, or storage tier. These logical/mathematical manipulations may relate to certain business rules, or processes that govern the software application as a whole. A third, storage tier, may be a persistent storage medium or, non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer to peer, or so some other suitable configuration. Further, these three tiers may be distributed between more than one computer system as various software components.

### Component Design

Some example embodiments may include the above illustrated tiers, and processes or operations that make them up, as being written as one or more software components. Common too many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above illustrated components across a distributed programming environment as distributed computing components. For example, an interface component (e.g., an interface tier) may reside on a first computer system that is remotely located from a second computer system containing a logic component (e.g., a logic tier). These first and second computer systems may be configured in a server-client, peer-to-peer, or some other suitable configuration. These various components may be written using the above illustrated object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the OSI model, or TCP/IP protocol stack model for defining the protocols used by a network to transmit data.

### A System of Transmission Between a Server and Client

Some embodiments may utilize the OSI model or TCP/IP protocol stack model for defining the protocols used by a network to transmit data. In applying these models, a system of data transmission between a server and client, or between peer computer systems is illustrated as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

### A Computer System

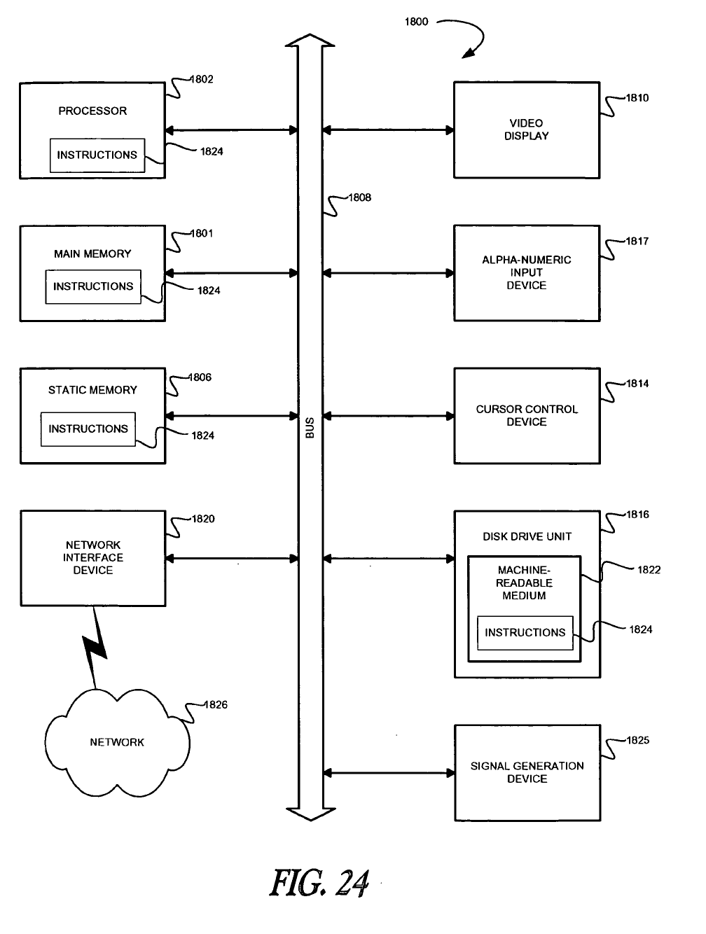

FIG. 24 shows a diagrammatic representation of a machine in the example form of a computer system 1800 that executes a set of instructions to perform any one or more of the methodologies discussed herein. The system 10 shown in FIG. 1, the system 100, shown in FIG. 2, the system 200, shown in FIG. 3, the system 300, shown in FIG. 4, and the system 400, shown in FIG. 5, may be configured as one or more computer systems 1800. The commerce site 106 shown in FIG. 2, the banking site 206 shown in FIG. 3, the telecom site 306 shown in FIG. 4, and the ISP site shown in FIG. 5 may be configured as one or more computer systems 1800. Further, the aggregating server 505 shown in FIG. 6 may be configured as one or more computer systems 1800. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a PC, a tablet PC, a Set-Top Box (STB), a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 1800 includes a processor 1802 (e.g., a Central Processing Unit (CPU), a Graphics Processing Unit (GPU) or both), a main memory 1801, and a static memory 1806, which communicate with each other via a bus 1808. The computer system 1800 may further include a video display unit 1810 (e.g., a Liquid Crystal Display (LCD) or a Cathode Ray Tube (CRT)). The computer system 1800 also includes an alphanumeric input device 1817 (e.g., a keyboard), an interface or graphical user interface (GUI) cursor controller 1814 (e.g., a mouse), a disk drive unit 1816, a signal generation device 1825 (e.g., a speaker) and a network interface device (e.g., a transmitter) 1820.

The disk drive unit 1816 includes a machine-readable medium 1822 on which is stored one or more sets of instructions and data structures (e.g., software) embodying or used by any one or more of the methodologies or functions illustrated herein. The software may also reside, completely or at least partially, within the main memory 1801 and/or within the processor 1802 during execution thereof by the computer system 1800, the main memory 1801 and the processor 1802 also constituting machine-readable media.

The instructions 1824 may further be transmitted or received over a network 1826 via the network interface device 1820 using any one of a number of well-known transfer protocols (e.g., HTTP, Session Initiation Protocol (SIP)).

The term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

### Marketplace Applications

In some example embodiments, a system and method is disclosed that allows individuals to graphically display graphs containing nodes and edges. The nodes may represent accounts, and the edges may represent associations between these accounts. Some example embodiments may include expanding a node as represented in graph so as to display additional data regarding a node(s) and the edges that may connect a node(s). The additional data may include the specific details relating to the nature of the edge (e.g., transaction) between two nodes. Higher levels of granularity may be able to be displayed via the additional data.

The Abstract of the Disclosure is provided to comply with 37 C.F.R. §1.72(b), requiring an abstract that may allow the reader to quickly ascertain the nature of the technical disclosure. It is submitted with the understanding that it may not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is

1. A system comprising:
a graph generator module configured to receive account information that identifies a first account and generate a first graph based on the first account, the first graph including a first score; and
a graph display module configured to communicate a first interface to a first agent that is selected from a plurality of agents, the first interface includes the first graph, the first graph represents the first account as a first node, the first graph further represents a first plurality of accounts as a first plurality of nodes that include the first node, and the first graph further represents a first plurality of account associations between the first plurality of accounts as a first plurality of edges that connect the first plurality of nodes.

2. The system of claim 1, further including:
a graph repository; and
a review queue that is included in the graph repository, wherein the graph generator module is configured to identify the first plurality of accounts based on the first account, the first plurality of accounts include the first account, the first plurality of accounts respectively being associated with the first account based on the first plurality of account associations between the first plurality of accounts, and wherein the graph generator module stores the first graph in the graph repository that includes the review queue, and wherein the graph generator module stores the first graph to the review queue based on the first score.

3. The system of claim 2, wherein the graph display module removes the first graph for review from the review queue based on the first score.

4. The system of claim 1, wherein the first plurality of accounts includes a second account, and wherein the first plurality of account associations includes a first association between the first account and the second account, and wherein the first association includes a transaction that includes a transfer of money from the first account to the second account.

5. The system of claim 4, wherein the first plurality of account associations includes a second association between the first account and the second account, and wherein the second association includes a link between the first account and the second account, and wherein the link is selected from a group of links that includes a shared email address link, a shared credit card link, and a shared telephone number link.

6. The system of claim 1, wherein the graph generator module is configured to generate metrics based on the first graph, wherein the metrics are selected from a group of metrics including a number of suspicious accounts included in the first plurality of accounts, a number of accounts included in the first plurality of accounts that are identified as bad, the average age of the first plurality of accounts, and a standard deviation of the age of the first plurality of accounts.

7. The system of claim 1, further including:
a node crawling module to automatically identify a status for a second account, wherein the first plurality of accounts includes the second account and.

8. The system of claim 1, wherein the graph generator module is configured to generate a second graph, identifies the second graph overlaps the first graph, wherein the overlap includes an identification that the second graph includes at least one node that is also included in the first graph, merges the second graph into the first graph in response to the identification the second graph overlaps the first graph, wherein the merge includes an addition of at least one node from the second graph to the first graph and an addition of at least one edge from the second graph to the first graph, and regenerates the first score for the first graph.

9. The system of claim 1, wherein the graph display module receives graph metadata for the first graph, stores the graph metadata for the first graph with the first graph on a watch queue to enable a watch of the first graph for new activity.

10. The system of claim 2, wherein the graph generator module is configured to identify no new activity for the first graph for a predetermined period of time and purges the first graph from the graph repository.

11. The system of claim 1, wherein the graph generator module is configured to identify no new activity for a predetermined period of time for the first node and prunes the first node from the first graph.

12. A method comprising:
receiving account information that identifies a first account;
generating a first graph based on the first account, the first graph including a first score; and
communicating a first interface to a first agent that is selected from a plurality of agents, the first interface including the first graph, the first graph representing the first account as a first node, the first graph further representing a first plurality of accounts as a first plurality of nodes including the first node, and the first graph further representing a first plurality of account associations between the first plurality of accounts as a first plurality of edges connecting the first plurality of nodes, the communicating done at least in part through the use of one or more processors.

13. The method of claim 12, wherein the generating the first graph includes:
identifying the first plurality of accounts based on the first account, the first plurality of accounts including the first account, the first plurality of accounts respectively associated with the first account based on the first plurality of account associations between the first plurality of accounts; and
storing the first graph in a graph repository that includes a review queue, wherein the storing includes adding the first graph to the review queue based on the first score.

14. The method of claim 13, wherein the communicating the first graph includes dequeueing the first graph for review from the review queue based on the score.

15. The method of claim 12, wherein the first plurality of accounts includes a second account, and wherein the first plurality of account associations includes a first association between the first account and the second account, and wherein the first association includes a transaction that includes a transfer of money from the first account to the second account.

16. The method of claim 15, wherein the first plurality of account associations includes a second association between the first account and the second account, and wherein the second association includes a link between the first account and the second account, and wherein the link is selected from a group of links including a shared email address link, a shared credit card link, and a shared telephone number link.

17. The method of claim 12, wherein the generating the first graph includes generating metrics based on the first graph, wherein the metrics are selected from a group of metrics including a number of suspicious accounts included in the first plurality of accounts, a number of accounts included in the first plurality of accounts that are identified as bad, the average age of the first plurality of accounts, and a standard deviation of the age of the first plurality of accounts.

18. The method of claim 12, wherein the first plurality of accounts includes a second account and further including automatically identifying a status for the second account.

19. The method of claim 12, further including:
generating a second graph;
identifying the second graph overlaps the first graph by identifying the second graph includes at least one node that is also included in the first graph;
merging the second graph into the first graph in response to the identifying the second graph overlaps the first graph, wherein the merging includes adding at least one node from the second graph to the first graph and by adding at least one edge from the second graph to the first graph; and
regenerating the first score for the first graph.

20. The method of claim 12, further including:
receiving graph metadata for the first graph;
storing the graph metadata for the first graph with the first graph on a watch queue the first graph for new activity;
identifying the new activity for the first graph, wherein the new activity includes adding a second node to the first graph; and
communicating a second interface to the first agent responsive to the identifying the new activity, and wherein the second interface includes the first graph, and wherein the first graph includes the second node, and wherein the first graph highlights the second node that was added to the first graph.

21. The method of claim 13, further including:
identifying no new activity for the first graph for a predetermined period of time; and
purging the first graph from the graph repository.

22. The method of claim 12, further including:
identifying no new activity for a predetermined period of time for the first node;
pruning the first node from the first graph.

23. Using one or more processors to execute instructions retained in machine readable media to perform at least some of the portion of the following actions:
receive account information that identifies a first account; and
generate a first graph based on the first account, the graph including a first score; and
communicating a first interface to a first agent that is selected from a plurality of agents, the first interface including the first graph, the first graph representing the first account as a first node, the first graph further representing a first plurality of accounts as a first plurality of nodes including the first node, and the first graph further representing a first plurality of account associations between the first plurality of accounts as a first plurality of edges connecting the first plurality of nodes, the communicating done at least in part through the use of one or more processors.

24. A system comprising:
a means configured to receive account information that identifies a first account and generate a first graph based on the first account, the graph including a first score; and
a graph display module configured to communicate a first interface to a first agent that is selected from a plurality of agents, the first interface includes the first graph, the first graph represents the first account as a first node, the first graph further represents a first plurality of accounts as a first plurality of nodes that include the first node, and the first graph further represents a first plurality of account associations between the first plurality of accounts as a first plurality of edges that connect the first plurality of nodes.
